(19) United States
(12) Patent Application Publication
(10) Pub. No.: US 2023/0025406 A1
(43) Pub. Date: Jan. 26, 2023

(54) ION CONDUCTING BATTERIES WITH SOLID STATE ELECTROLYTE MATERIALS

(71) Applicant: University of Maryland, College Park, College Park, MD (US)

(72) Inventors: Eric D. Wachsman, (US); Liangbing Hu, Hyattsville, MD (US); Venkataraman Thangadurai, Calgary (CA); Gregory Thomas Hitz, Riverdale Park, MD (US); Dennis McOwen, College Park, MD (US)

(21) Appl. No.: 17/951,873

(22) Filed: Sep. 23, 2022

Related U.S. Application Data
(63) Continuation of application No. 16/847,582, filed on Apr. 13, 2020.
Application No. 16/847,582 is a continuation-in-part of application No. 15/364,528, filed on Nov. 30, 2016, now abandoned.
Application No. 16/847,582 is a continuation-in-part of application No. 14/222,306, filed on Mar. 21, 2014, now Pat. No. 10,622,666.
(60) Provisional application No. 62/260,817, filed on Nov. 30, 2015.
(60) Provisional application No. 61/803,981, filed on Mar. 21, 2013.

(51) Int. Cl. H01M 4/80; H01M 10/0525; H01M 10/0565

(52) U.S. Cl. CPC H01M 4/80; H01M 10/0525; H01M 10/0565; H01M 2300/0085; H01M 2004/021

(57) ABSTRACT

Batteries and battery cells are described including batteries and battery cells having solid-state components such as porous and/or dense solid state components. Aspects of dimensions, porosity and pore structure are also described.

### CROSS-REFERENCE TO RELATED APPLICATIONS

This application is a continuation-in-part of U.S. patent application Ser. No. 14/222,306, filed on Mar. 21, 2014 which claims the benefit of U.S. Provisional Patent Appl. No. 61/803,981, filed Mar. 21, 2013, and a continuation-in-part of U.S. patent application Ser. No. 15/364,528, filed on Nov. 30, 2016 which claims the benefit of U.S. Provisional Patent Appl. No. 62/260,817, filed on Nov. 30, 2015, the disclosure of which are all incorporated herein by reference in their entireties.

### STATEMENT REGARDING FEDERALLY SPONSORED RESEARCH

This invention was made with government support under contract no. DEAR0000384 awarded by the United States Department of Energy. The government has certain rights in the invention.

### FIELD OF THE DISCLOSURE

The present disclosure generally relates to ion conducting batteries including those with solid-state electrolytes, structures such as ceramic ion-conducting structures, ceramic ion conducting structures for use in ion-conducting batteries.

### BACKGROUND OF THE DISCLOSURE

Lithium ion batteries (LiBs) have the highest volumetric and gravimetric energy densities compared to all other rechargeable batteries making LiBs the prime candidate for a wide range of applications, from portable electronics to electric vehicles (EVs). Current LiBs are based mainly on LiCoO₂ or LiFePO₄ type positive electrodes, a Li⁺ conducting organic electrolyte (e.g., LiPF₆ dissolved in ethylene carbonate-diethyl carbonate), and a Li metal or graphitic anode. Unfortunately, there are several technological problems that exist with current state-of-the art LiBs: safety due to combustible organic components; potential for Li dendrite shorting across the organic electrolytes degradation due to the formation of reaction products at the anode and cathode electrolyte, interfaces (solid electrolyte interphase—SEI); and power/energy density limitations by poor electrochemical stability of the organic electrolyte such as with respect to both Li-metal anodes and higher voltage cathodes. Other batteries based sodium, magnesium, and other ion conducting electrolytes have similar issues.

### BRIEF SUMMARY OF THE DISCLOSURE

In a first aspect disclosed herein a solid-state, ion-conducting battery is provided. The solid-state ion-conducting battery comprising: (a) cathode material or anode material; (b) a solid-state electrolyte (SSE) material comprising a porous region having a plurality of pores, and a dense region, where the cathode material or the anode material is disposed on at least a portion of the porous region and the dense region is free of the cathode material and the anode material, and a current collector disposed on at least a portion of the cathode material or the anode material.

In an embodiment of the first aspect, the SSE material comprises two of the porous regions, the battery comprises the cathode material and the anode material, and the cathode material is disposed on at least a portion of one of the porous regions forming a cathode-side porous region and the anode material is disposed on at least a portion of the other porous region forming an anode-side porous region, and the cathode-side region and the anode-side region are disposed on opposite sides of the dense region, and further comprises a cathode-side current collector and an anode-side current collector.

In an embodiment of the first aspect, the cathode material is a lithium-containing material, a sodium-containing cathode material, or a magnesium-containing cathode material. In an embodiment, the cathode material comprises a conducting carbon material, and the cathode material, optionally, further comprises an organic or gel ion-conducting electrolyte. In an embodiment, the lithium-containing electrode material is a lithium-containing, ion-conducting cathode material selected from LiCoO₂, LiFePO₄, Li₂MMn₃O₈, wherein M is selected from Fe, Co, and combinations thereof. In an embodiment, the sodium-containing cathode material is a sodium-containing, ion-conducting cathode material is selected from Na₂V₂O₅, P2-Na_{2/3}Fe_{1/2}Mn_{1/2}O₂, Na₃V₂(PO₄)₃, NaMn_{1/3}Co_{1/3}N_{1/3}PO₄, and Na_{2/3}Fe_{1/2}Mn_{1/2}O₂@graphene composite. In an embodiment, the magnesium-containing cathode material is a magnesium-containing, ion-conducting cathode material and is a doped manganese oxide.

In an embodiment of the first aspect, the anode material is a lithium-containing anode material, a sodium-containing anode material, or a magnesium-containing anode material. In an embodiment, the lithium-containing anode material is lithium metal. In an embodiment, the sodium-containing anode material is sodium metal or an ion-conducting, sodium-containing anode material selected from Na₂C₈H₄O₄ and Na_{0.66}Li_{0.22}Ti_{0.78}O₂. In an embodiment, the magnesium-containing anode material is magnesium metal.

In an embodiment of the first aspect, the SSE material is a lithium-containing SSE material, a sodium-containing SSE material, or a magnesium-containing SSE material. In an embodiment, the lithium-containing SSE material is a Li-garnet SSE material. In an embodiment, the Li-garnet SSE material is cation-doped Li₅ La₃M¹₂O₁₂, where M₁ is Nb, Zr, Ta, or combinations thereof, cation-doped Li₆La₂BaTa₂O₁₂, cation-doped Li₇La₃Zr₂O₁₂, and cation-doped Li₆BaY₂M₁₂O₁₂, where cation dopants are barium, yttrium, zinc, or combinations thereof. In an embodiment, the Li-garnet SSE material is Li₅La₃Nb₂O₁₂, Li₅La₃Ta₂O₁₂, Li₇La₃Zr₂O₁₂, Li₆La₂SrNb₂O₁₂, Li₆La₂BaNb₂O₁₂, Li₆La₂SrTa₂O₁₂, Li₆La₂BaTa₂O₁₂, Li₇Y₃Zr₂O₁₂, Li₆₄Y₃Zr₁₄Ta_{0.6}O₁₂, Li_{6.5}La_{2.5}Ba_{0.5}TaZrO₁₂, Li₆BaY₂M₁₂O₁₂, Li₇Y₃Zr₂O₁₂, Li_{6.75}BaLa₂Nb_{1.75}Zn_{0.25}O₁₂, or Li_{6.75}BaLa₂Ta_{1.75}Zn_{0.25}O₁₂.

In an embodiment of the first aspect, the current collector is a conducting metal or metal alloy.

In an embodiment of the first aspect, the dense region of the SSE material has a dimension of 1 μm to 100 μm and/or the porous region of the SSE material that has the cathode material disposed thereon has a dimension of 20 μm to 200 μm and/or the porous region of the SSE material that has the anode material disposed thereon has a dimension of 20 μm to 200 μm.

In an embodiment of the first aspect, the ion-conducting cathode material, the ion-conducting anode material, the SSE material, and the current collector form a cell, and the solid-state, ion-conducting battery comprises a plurality of the cells, each adjacent pair of the cells is separated by a bipolar plate.

In a second aspect disclosed herein a solid-state, ion-conducting battery is provided. The solid-state, ion-conducting battery comprising a solid-state electrolyte (SSE) material comprising a porous region of electrolyte material disposed on a dense region of electrolyte material, the SSE material configured such that ions diffuse into and out of the porous region of the SSE material during charging and/or discharging of the battery. In an embodiment, the SSE material comprises two porous regions disposed on opposite sides of the dense region of the SSE material.

In a third aspect disclosed herein, ceramic ion-conducing structures (e.g., ceramic ion-conducing materials having particular structural features and/or properties) are provided. The ceramic ion-conducting structures can be in the form of a single layer or multilayer structures. For example, a multilayer structure can comprise layers of ceramic ion-conducing structures, where the individual layers have the same or different porosity. The ceramic ion-conducing structures can be ion-conducting electrolyte materials (e.g., solid-state electrolyte materials). The ion-conducing ceramic structures can be formed by a method (e.g., a tape casting method) disclosed herein. For example, a ceramic ion-conducing structure is formed by a method disclosed herein.

In an embodiment of the third aspect, a ceramic ion-conducting structure can be a layer. The ceramic ion-conducing structures can have a dense region (e.g., a dense layer) and one (e.g., a bilayer structure) or two (e.g., a triple layer structure) porous regions (e.g., porous layer(s)). The porosity of the dense region is less than that of the porous region(s). A cathode material and/or an anode material can be disposed on a porous region of a ceramic ion-conducing structure forming a discrete cathode-material containing region and/or a discrete anode-material containing region of the ceramic ion-conducing structure. It is desirable that a ceramic ion-conducing structure not allow dendrites to form (form dendrites) during cycling. Accordingly, in an example, the ceramic ion-conducing material (or a ceramic ion-conducting structure) does not have observable dendrites (e.g., lithium dendrites).

In a fourth aspect disclosed herein, methods of fabricating ceramic-ionic conducing structures are provided. The methods are based on particular slurry formulation methods and/or particular sintering methods. The methods can be tape casting methods. A method of fabricating ceramic ionic-conducing structures can comprise forming a slurry. The slurry can be used in a tape casting method. The order of addition of components (starting materials) during formation of the slurry and/or milling time(s) can be critical.

In a fifth aspect disclosed herein, uses of ceramic ion-conducing structures are provided. For example, the ceramic ion conducing structures can be used as solid-state electrolyte materials in ion-conducing batteries (e.g., solid-state ion-conducing batteries). An ion-conducting battery can comprise ion-conducting solid state electrolyte comprising one or more ceramic ion conducing material of the present disclosure.

In a sixth aspect disclosed herein a battery cell is provided. The battery cell comprising: a solid-state dense region having a porosity of less than 5%; and a solid-state first porous region having a porosity of 40% to 90%, wherein a cathode material or an anode material is disposed on at least a portion of the first porous region, the first porous region comprises pores and the pores interconnectedly connect opposing sides of the first porous region.

In a first embodiment of the sixth aspect, the pores interconnectedly connect an interface between the first porous region and the dense region and an interface between the first porous region and a current collector.

In a second embodiment of the sixth aspect, one of the opposing sides of the first porous region is at an interface between the first porous region and the dense region.

In a third embodiment of the sixth aspect, the dense region is too thin to be self-supporting and the dense region is supported by the first porous region.

In a fourth embodiment of the sixth aspect, the dense region is free of the cathode material and the anode material.

In a fifth embodiment of the sixth aspect, particles of the first porous region are fused into the dense region.

In a sixth embodiment of the sixth aspect, the battery cell further comprises: a second solid-state porous region having a porosity of 40% to 90%, a first current collector disposed on the first porous region, and a second current collector disposed on the second porous region, wherein, the second porous region comprises pores and the pores connect opposing sides of the second porous region, the cathode material is disposed on a portion of the first porous region forming a cathode-side porous region, the anode material is disposed on a portion of the second porous region forming an anode-side porous region, and the anode-side region and the cathode-side region are disposed on opposite sides of the dense region.

In a seventh embodiment of the sixth aspect, the dense region has a thickness of 1 to 40 microns.

In an eighth embodiment of the sixth aspect, the dense region has a thickness of 5 to 40 microns.

In a ninth embodiment of the sixth aspect, the anode material is disposed on the at least a portion of the first porous region and the cathode material present in a cathode that comprises an organic or a gel electrolyte.

In a tenth embodiment of the sixth aspect, the anode material is disposed on the at least a portion of the first porous region and the cathode material present in a cathode that comprises a liquid electrolyte

In an eleventh embodiment of the sixth aspect, the porous region is a ceramic that was made with a porogen comprising one or more elemental carbon-containing materials.

In a twelfth embodiment of the sixth aspect, the porous region is a ceramic that was made with a porogen comprising one or more materials selected from the group consisting of natural fibers, starches, polymer materials and combinations thereof.

In a thirteenth embodiment of the sixth aspect, the porous region is a ceramic that was made with a porogen comprising a first material that is or comprises an elemental carbon-containing material and a second material that is or comprises a material selected from the group consisting of natural fibers, starches, polymer materials and combinations thereof.

In a seventh aspect disclosed herein, a solid-state, ion-conducting battery cell is provided. The solid-state, ion-conducting battery cell comprising: a cathode comprising a cathode material or an anode comprising an anode material; a solid-state electrolyte (SSE) material comprising a first porous region of sintered particles having a plurality of pores, and a dense region having a thickness that is too thin to be self-supporting, wherein the cathode material or the anode material is disposed on at least a portion of the first porous region, and wherein the dense region is supported by the first porous region.

In a first embodiment of the seventh aspect, the dense region has a porosity of less than 5%, and the first porous region having a porosity of 40% to 90%.

In a second embodiment of the seventh aspect, the plurality of pores interconnectedly connect opposing sides of the first porous region

In a third embodiment of the seventh aspect, the plurality of pores interconnectedly connect an interface between the first porous region and the dense region and another side of the first porous region which optionally is an opposing side of the first porous region.

In a fourth embodiment of the seventh aspect, the dense region is free of the cathode material and the anode material.

In a fifth embodiment of the seventh aspect, particles of the first porous region are fused into the dense region.

In a sixth embodiment of the seventh aspect, the anode material is disposed on the at least a portion of the first porous region and the cathode comprises an organic or a gel electrolyte.

In a seventh embodiment of the seventh aspect, the solid-state ion-conducting battery cell further comprises a second porous region having a porosity of 40% to 90%, a first current collector disposed on the first porous region, and a second current collector disposed on the second porous region, wherein, the second porous region comprises pores and the pores connect opposing sides of the second porous region, the cathode material is disposed on a portion of the first porous region forming a cathode-side porous region, the anode material is disposed on a portion of the second porous region forming an anode-side porous region, and the anode-side region and the cathode-side region are disposed on opposite sides of the dense region.

In an eighth embodiment of the seventh aspect, the dense region has a thickness of 1 to 40 microns.

In a ninth embodiment of the seventh aspect, the dense region has a thickness of 5 to 40 microns.

### BRIEF DESCRIPTION OF THE FIGURES

The following figures are given by way of illustration only, and thus are not intended to limit the scope of the present disclosure.

FIG. 1. Ionic conductivity vs. diffusion coefficient of garnet-type compounds: (1) Li₅La₃Ta₂O₁₂, (2) Li₅La₃Sb₂O₁₂, (3) Li₅La₃Nb₂O₁₂, (4) Li_{5.5}BaLa₂Ta₂O_{11.75}, (5) Li₆La₂BaTaO₁₂, (6) Li_{6.5}BaLa₂Ta₂O_{12.25}, (7) Li₇La₃Zr₂O₁₂, (8) Li_{6.5}La_{2.5}Ba_{0.5}TaZrO₁₂ (sintered at 900° C.), and (9) Li_{6.5}La_{2.5}Ba_{0.5}TaZrO₁₂ (sintered at 1100° C.).

FIG. 2. Example of optimization of Li ion conduction in garnet-type solid state electrolytes (SSEs): (a) and (b) path of Li⁺ conduction and (c) effect of Li⁺ site occupancy on conductivity.

FIG. 3. Schematic of an example of the solid-state lithium battery (SSLiB) showing thin (˜10 μm) garnet SSE layer extending as a tailored nano/microstructured scaffold into (Li metal filled) anode and (Li₂MMn₃O₈, M=Fe, Co, mixed with graphene) cathode to provide structural support for solid-state electrolyte (SSE) layer, and high surface area and continuous ion transport path for reduced polarization. The multi-purpose ˜40 μm Al current collector (with ˜200 Å Cu on anode side) provides strength and thermal and electrical conduction. The ˜170 μm repeat units are stacked in series to provide desired battery pack voltage and strength (300V pack would be <1 cm thick). Highly porous SSE scaffold creates large interface area significantly decreasing cell impedance.

FIG. 4. (a) Ionic conductivity of examples of Li-garnets. (b) PXRD of an example of a Li_{6.75}La₂BaTa_{1.75}Zn_{0.25}O₁₂.

FIG. 5. Electrochemical impedance spectroscopy (EIS) of an example of a SSE battery with LiFePO₄ cathode (20% carbon black), dense SSE, Li infiltrated SSE scaffold, and Al current collector. The absence of additional low-frequency intercept indicates electrolyte interface is reversible for Li ions.

FIG. 6. PXRD showing the formation of a garnet-type Li_{6.75}La₂BaTa_{1.75}Zn_{0.25}O₁₂ as a function of temperature, SEM images and conductivity show sintering temperature can control the density, particle size, and conductivity.

FIG. 7. Examples of multilayer ceramic processing: (a) tape cast support; (b) thin electrolyte on layered porous anode support with bimodally integrated anode functional layer (BI-AFL); and (c) magnification of BI-AFL showing ability to integrate nano-scale features for reduced interfacial impedance with conventional ceramic processing.

FIG. 8. (a) Cross section and (b) top view of an example of a SSE with porous scaffold, in which anode and cathode materials will be filled. (c) Cross-section of SSE scaffold after Li metal infiltration. (d) Cross section at Li-metal-dense SSE interface. Images demonstrate excellent Li wetting of SSE was obtained.

FIG. 9 shows SEM micrographs of (a) a triple layer ceramic with ˜5 μm pores, (b) a triple layer ceramic with ˜10 μm pores, (c) a close-up of highly interconnected porosity in a triple layer, and (d) an ordered structure on the bottom of a bilayer.

FIG. 10 shows an analysis of calcined LLCZN showing phase via (a) X-ray diffraction and particle size via (b) scanning electron microscopy and (c) dynamic light scattering.

FIG. 11 shows (a) a diagram and photograph of reactor setup used for testing LLZ under varying gas conditions. (b) XRD patterns of LLZ powders heated to 500° C. in zero-grade air. (c) XRD patterns of LLZ powders heated in CO₂. (d) XRD pattern of LLZ tape heated in compressed air.

FIG. 12 show (a) SEM micrograph of solid state LLCZN after milling in 5 mm and 2 mm media. (b) Dilatometer curve of a pressed LLCZN pellet during heating at 1° C./minute.

FIG. 13 shows XRD of LLCZN tapes after burn out in dry air and sintering at 1050° C. for 1 hour in various gases.

FIG. 14 shows SEM micrographs of an example of an ordered structure by 3D printing garnet on top of a dense garnet tape after sintering, such as a 10 layer print on top of a dense tape after sintering.

FIG. 15 shows (a) ASR vs running time data, current vs. time data, and voltage vs. time data for an example of a ceramic ion-conducting structure. (b) Additional ASR vs running time data, current vs. time data, and voltage vs. time data for an example of a ceramic ion-conducting structure.

FIG. 16 shows ASR vs. dense layer thickness for examples of ceramic ion-conducting structures.

FIG. 17 shows a schematic (top left) and corresponding SEM image (top right, bottom left, and bottom right) showing the designed trilayer garnet structure with more Li cycled at one side.

FIG. 18 shows a colormap of grid scanned trilayer sintered with starting point sintering setup.

FIG. 19 shows a 3D plot of a grid scan background and the curve fit to the background.

FIG. 20 shows a colormap of grid scans of two cells sintered using (a) a finely ground powder and (b) a ceramic pellet on top and bottom

### DETAILED DESCRIPTION OF THE DISCLOSURE

The present disclosure provides ion conducting batteries having a solid state electrolyte. For example, the batteries are lithium-ion, solid-state electrolyte batteries, sodium-ion, solid-state electrolyte batteries, or magnesium-ion solid-state electrolyte batteries. Lithium-ion (Li⁺) batteries are used, for example, in portable electronics and electric cars, sodium-ion (Na⁺) batteries are used, for example, for electric grid storage to enable intermittent renewable energy deployment such as solar and wind, and magnesium-ion (Mg²⁺) batteries are expected to have higher performance than Li⁺ and Na⁺ because Mg²⁺ carries twice the charge for each ion.

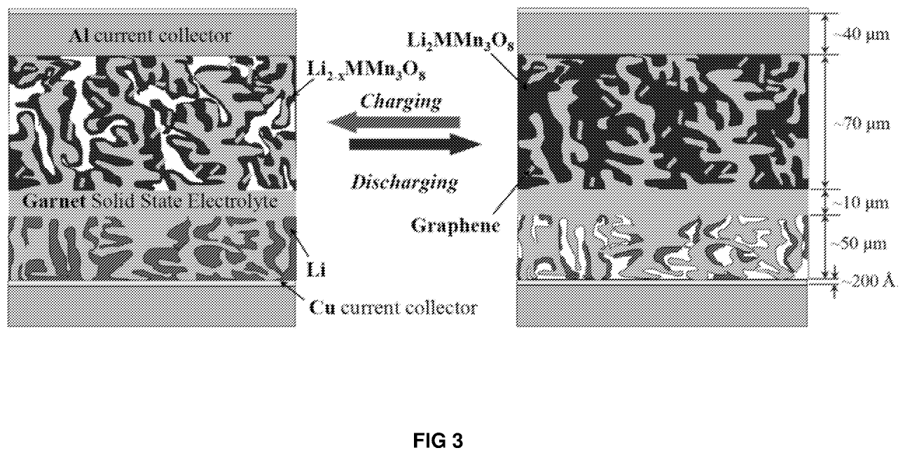

The solid-state batteries have advantages over previous batteries. For example, the solid electrolyte is non-flammable providing enhanced safety, and also provides greater stability to allow high voltage electrodes for greater energy density. The battery design (FIG. 3) provides additional advantages in that it allows for a thin electrolyte layer and a larger electrolyte/electrode interfacial area, both resulting in lower resistance and thus greater power and energy density. In addition, the structure eliminates mechanical stress from ion intercalation during charging and discharging cycles and the formation of solid electrolyte interphase (SEI) layers, thus removing the capacity fade degradation mechanisms that limit lifetime of current battery technology.

The solid state batteries comprise a cathode material, an anode material, and an ion-conducting, solid-state electrolyte material. The solid-state electrolyte material has a dense region (e.g. a layer) and one or two porous regions (layers). The porous region(s) can be disposed on one side of the dense region or disposed on opposite sides of the dense region. The dense region and porous region(s) are fabricated from the same solid-state electrolyte material. The batteries conduct ions such as, for example, lithium ions, sodium ions, or magnesium ions.

The cathode comprises cathode material in electrical contact with the porous region of the ion-conducting, solid-state electrolyte material. For example, the cathode material is an ion-conducting material that stores ions by mechanisms such as intercalation or reacts with the ion to form a secondary phase (e.g., an air or sulfide electrode). Examples of suitable cathode materials are known in the art.

The cathode material, if present, is disposed on at least a portion of a surface (e.g., a pore surface of one of the pores) of a porous region of the ion-conducting, solid-state electrolyte material. The cathode material, when present, at least partially fills one or more pores (e.g., a majority of the pores) of a porous region or one of the porous regions of the ion-conducting, solid-state electrolyte material. In an embodiment, the cathode material is infiltrated into at least a portion of the pores of the porous region of the ion-conducting, solid-state electrolyte material.

In an embodiment, the cathode material is disposed on at least a portion of the pore surface of the cathode side of the porous region of the ion-conducting, SSE material, where the cathode side of the porous region of ion-conducting, SSE material is opposed to an anode side of the porous region of ion-conducting, SSE material on which the anode material is disposed.

In an embodiment, the cathode material is a lithium ion-conducting material. For example, the lithium ion-conducting cathode material is, lithium nickel manganese cobalt oxides (NMC, LiNiₓMn_{y}Co_{z}O₂, where x+y+z=1), such as LiCoO₂, LiNi_{1/3}Co_{1/3}Mn_{1/3}O₂, LiNi_{0.5}Co_{0.2}Mn_{0.3}O₂, lithium manganese oxides (LMOs), such as LiMn₂O₄, LiNi_{0.5}Mn_{1.5}O₄, lithium iron phosphates (LFPs) such as LiFePO₄, LiMnPO₄, and LiCoPO₄, and Li₂MMn₃O₈, where M is selected from Fe, Co, and combinations thereof. In an embodiment, the ion-conducting cathode material is a high energy ion-conducting cathode material such as Li₂MMn₃O₈, wherein M is selected from Fe, Co, and combinations thereof.

In an embodiment, the cathode material is a sodium ion-conducting material. For example, the sodium ion-conducting cathode material is Na₂V₂O₅, P2-Na_{2/3}Fe_{1/2}Mn_{1/2}O₂, Na₃V₂(PO₄)₃, NaMn_{1/3}Co_{1/3}Ni_{1/3}PO₄ and composite materials (e.g., composites with carbon black) thereof such as Na_{2/3}Fe_{1/2}Mn_{1/2}O₂@graphene composite.

In an embodiment, the cathode material is a magnesium ion-conducting material. For example, the magnesium ion-conducting cathode material is doped manganese oxide (e.g., MgₓMnO_{2.y}H₂O).

In an embodiment, the cathode material is an organic sulfide or polysulfide. Examples of organic sulfides include carbynepolysulfide and copolymerized sulfur.

In an embodiment, the cathode material is an air electrode. Examples of materials suitable for air electrodes include those used in solid-state lithium ion batteries with air cathodes such as large surface area carbon particles (e.g., Super P which is a conductive carbon black) and catalyst particles (e.g., alpha-Mno₂ nanorods) bound in a mesh (e.g., a polymer binder such as PVDF binder).

It may be desirable to use an electrically conductive material as part of the ion-conducting cathode material. In an embodiment, the ion-conducting cathode material also comprises an electrically conducting carbon material (e.g., graphene or carbon black), and the ion-conducting cathode material, optionally, further comprises a organic or gel ion-conducting electrolyte. The electrically conductive material may separate from the ion-conducting cathode material. For example, electrically conductive material (e.g., graphene) is disposed on at least a portion of a surface (e.g., a pore surface) of the porous region of the ion-conducting, SSE electrolyte material and the ion-conducting cathode material is disposed on at least a portion of the electrically conductive material (e.g., graphene).

The anode comprises anode material in electrical contact with the porous region of the ion-conducting, SSE material. For example, the anode material is the metallic form of the ion conducted in the solid state electrolyte (e.g., metallic lithium for a lithium-ion battery) or a compound that intercalates the conducting ion (e.g., lithium carbide, Li₆C, for a lithium-ion battery). Examples of suitable anode materials are known in the art.

The anode material, if present, is disposed on at least a portion of a surface (e.g., a pore surface of one of the pores) of the porous region of the ion-conducting, SSE material. The anode material, when present, at least partially fills one or more pores (e.g., a majority of the pores) of the porous region of ion-conducting, SSE electrolyte material. In an embodiment, the anode material is infiltrated into at least a portion of the pores of the porous region of the ion-conducting, solid-state electrolyte material.

In an embodiment, the anode material is disposed on at least a portion of the pore surface of an anode-side porous region of the ion-conducting, SSE electrolyte material, where the anode side of the ion-conducting, solid-state electrolyte material is opposed to a cathode side of the porous, ion-conducting, SSE on which the cathode material is disposed.

In an embodiment, the anode material is a lithium-containing material. For example, the anode material is lithium metal, or an ion-conducting lithium-containing anode material such as lithium titanates (LTOs) such as Li₄Ti₅O₁₂.

In an embodiment, the anode material is a sodium-containing material. For example, the anode material is sodium metal, or an ion-conducting sodium-containing anode material such as Na₂C₈H₄O₄ and Na_{0.66}Li_{0.22}Ti_{0.78}O₂.

In an embodiment, the anode material is a magnesium-containing material. For example, the anode material is magnesium metal.

In an embodiment, the anode material is a conducting material such as graphite, hard carbon, porous hollow carbon spheres and tubes, and tin and its alloys, tin/carbon, tin/cobalt alloy, or silicon/carbon.

The ion-conducting, solid-state electrolyte material has a dense regions (e.g., a dense layer) and one or two porous regions (e.g., porous layer(s)). The porosity of the dense region is less than that of the porous region(s). In an embodiment, the dense region is not porous. The cathode material and/or anode material is disposed on a porous region of the SSE material forming a discrete cathode material containing region and/or a discrete anode material containing region of the ion-conducting, solid-state electrolyte material. For example, each of these regions of the ion-conducting, solid-state electrolyte material has, independently, a dimension (e.g., a thickness perpendicular to the longest dimension of the material) of 20 μm to 200 μm, including all integer micron values and ranges therebetween.

The dense regions and porous regions described herein can be discrete dense layers and discrete porous layers. Accordingly, in an embodiment, the ion-conducting, solid-state electrolyte material has a dense layer and one or two porous layers.

The ion-conducting, solid-state electrolyte material conducts ions (e.g., lithium ions, sodium ions, or magnesium ions) between the anode and cathode. The ion-conducting, solid-state electrolyte material is free of pin-hole defects. The ion-conducting solid-state electrolyte material for the battery or battery cell has a dense region (e.g., a dense layer) that is supported by one or more porous regions (e.g., porous layer(s)) (the porous region(s)/layer(s) are also referred to herein as a scaffold structure(s)) comprised of the same ion-conducting, solid-state electrolyte material.

In an embodiment, the ion-conducting solid state electrolyte has a dense region (e.g., a dense layer) and two porous regions (e.g., porous layers), where the porous regions are disposed on opposite sides of the dense region and cathode material is disposed in one of the porous regions and the anode material in the other porous region.

In an embodiment, the ion-conducting solid state electrolyte has a dense region (e.g., a dense layer) and one porous region (e.g., porous layer), where the porous regions are disposed on one sides of the dense region and either cathode material or anode material is disposed in the porous region. If cathode material is disposed in the porous region, a conventional battery anode (e.g., a conventional solid-state battery anode) is formed on the opposite side of the dense region by known methods. If anode material is disposed in the porous region, a conventional battery cathode (e.g., a conventional solid-state battery cathode) is formed on the opposite side of the dense region.

The porous region (e.g., porous layer) of the ion-conducting, solid-state electrolyte material has a porous structure. The porous structure has microstructural features (e.g., microporosity) and/or nanostructural features (e.g., nanoporosity). For example, each porous region, independently, has a porosity of 10% to 90%, including all integer % values and ranges therebetween. In another example, each porous region, independently, has a porosity of 30% to 70%, including all integer % values and ranges therebetween. Where two porous regions are present the porosity of the two layers may be the same or different. The porosity of the individual regions can be selected to, for example, accommodate processing steps (e.g., higher porosity is easier to fill with electrode material (e.g., charge storage material) (e.g., cathode)) in subsequent screen-printing or infiltration step, and achieve a desired electrode material capacity, i.e., how much of the conducting material (e.g., Li, Na, Mg) is stored in the electrode materials. The porous region (e.g., layer) provide structural support to the dense layer so that the thickness of the dense layer can be reduced, thus reducing its resistance. The porous layer also extends ion conduction of the dense phase (solid electrolyte) into the electrode layer to reduce electrode resistance both in terms of ion conduction through electrode and interfacial resistance due to charge transfer reaction at electrode/electrolyte interface, the later improved by having more electrode/electrolyte interfacial area.

In an embodiment, the solid-state, ion-conducting electrolyte material is a solid-state electrolyte, lithium-containing material. For example, the solid-state electrolyte, lithium-containing material is a lithium-garnet SSE material.

In an embodiment, the solid-state, ion-conducting electrolyte material is a Li-garnet SSE material comprising cation-doped Li₅La₃M′₂O₁₂, cation-doped Li₆La₂BaTa₂O₁₂, cation-doped Li₇La₃Zr₂O₁₂, and cation-doped Li₆BaY₂M′₂O₁₂. The cation dopants are barium, yttrium, zinc, or combinations thereof and M′ is Nb, Zr, Ta, or combinations thereof.

In an embodiment, the Li-garnet SSE material comprises Li₅La₃Nb₂O₁₂, Li₅La₃Ta₂O₁₂, Li₇La₃Zr₂O₁₂, Li₆La₂SrNb₂O₁₂, Li₆La₂BaNb₂O₁₂, Li₆La₂SrTa₂O₁₂, Li₆La₂BaTa₂O₁₂, Li₇Y₃Zr₂O₁₂, Li_{6.4}Y₃Zr_{1.4}Ta_{0.6}O₁₂, Li_{6.5}La_{2.5}Ba_{0.5}TaZrO₁₂, Li₆BaY₂M¹₂O₁₂, Li₇Y₃Zr₂O₁₂, Li_{6.75}BaLa₂Nb_{1.75}Zn_{0.25}O₁₂, or Li_{6.75}BaLa₂Ta_{1.75}Zn_{0.25}O₁₂.

In an embodiment, the, solid-state, ion-conducting electrolyte material sodium-containing, solid-state electrolyte, material. For example, the sodium-containing, solid-state electrolyte is Na₃Zr₂Si₂PO₁₂ (NASICON) or beta-alumina.

In an embodiment, the, solid-state, ion-conducting electrolyte material is a, solid-state electrolyte, magnesium-containing material. For example, the magnesium ion-conducting electrolyte material is MgZr₄P₆O₂₄.

The ion-conducting, solid-state electrolyte material has a dense region that free of the cathode material and anode material. For example, this region has a dimension (e.g., a thickness perpendicular to the longest dimension of the material) of 1 μm to 100 μm, including all integer micron values and ranges therebetween. In another example, this region has a dimension of 5 μm to 40 μm.

In an embodiment, the solid state battery comprises a lithium-containing cathode material and/or a lithium-containing anode material, and a lithium-containing, ion-conducting, solid-state electrolyte material. In an embodiment, the solid state battery comprises a sodium-containing cathode material and/or a sodium-containing anode material, and a sodium-containing, ion-conducting, solid-state electrolyte material. In an embodiment, the solid state battery comprises a magnesium-containing cathode material and/or a magnesium-containing anode material, and a magnesium-containing, ion-conducting, solid-state electrolyte material.

The solid-state, ion-conducting electrolyte material is configured such that ions (e.g., lithium ions, sodium ions, or magnesium ions) diffuse into and out of the porous region(s) (e.g., porous layer(s)) of the solid-state, ion-conducting electrolyte material during charging and/or discharging of the battery. In an embodiment, the solid-state, ion-conducting battery comprises a solid-state, ion-conducting electrolyte material comprising one or two porous regions (e.g., porous layer(s)) configured such that ions (e.g., lithium ions, sodium ions, or magnesium ions) diffuse into and out of the porous region(s) of solid-state, ion-conducting electrolyte material during charging and/or discharging of the battery.

One of ordinary skill in the art would understand that a number of processing methods are known for processing/forming the porous, solid-state, ion-conducting electrolyte material such as high temperature solid-state reaction processes, co-precipitation processes, hydrothermal processes, sol-gel processes.

The material can be systematically synthesized by solid-state mixing techniques. For example, a mixture of starting materials may be mixed in an organic solvent (e.g., ethanol or methanol) and the mixture of starting materials dried to evolve the organic solvent. The mixture of starting materials may be ball milled. The ball milled mixture may be calcined. For example, the ball milled mixture is calcined at a temperature between 500° C. and 2000° C., including all integer ° C. values and ranges therebetween, for least 30 minutes to at least 50 hours. The calcined mixture may be milled with media such as stabilized-zirconia or alumina or another media known to one of ordinary skill in the art to achieve the prerequisite particle size distribution. The calcined mixture may be sintered. For example, the calcined mixture is sintered at a temperature between 500° C. and 2000° C., including all integer ° C. values and ranges therebetween, for at least 30 minutes to at least 50 hours. To achieve the prerequisite particle size distribution, the calcined mixture may be milled using a technique such as vibratory milling, attrition milling, jet milling, ball milling, or another technique known to one of ordinary skill in the art, using media such as stabilized-zirconia, alumina, or another media known to one of ordinary skill in the art.

One of ordinary skill in the art would understand that a number of conventional fabrication processing methods are known for processing the ion-conducting SSE materials such as those set forth above in a green-form. Such methods include, but are not limited to, tape casting, calendaring, embossing, punching, laser-cutting, solvent bonding, lamination, heat lamination, extrusion, co-extrusion, centrifugal casting, slip casting, gel casting, die casting, pressing, isostatic pressing, hot isostatic pressing, uniaxial pressing, and sol gel processing. The resulting green-form material may then be sintered to form the ion-conducting SSE materials using a technique known to one of ordinary skill in the art, such as conventional thermal processing in air, or controlled atmospheres to minimize loss of individual components of the ion-conducting SSE materials. In some embodiments of the present invention it is advantageous to fabricate ion-conducting SSE materials in a green-form by die-pressing, optionally followed by isostatic pressing. In other embodiments it is advantageous to fabricate ion-conducting SSE materials as a multi-channel device in a green-form using a combination of techniques such as tape casting, punching, laser-cutting, solvent bonding, heat lamination, or other techniques known to one of ordinary skill in the art.

Standard x-ray diffraction analysis techniques may be performed to identify the crystal structure and phase purity of the solid sodium electrolytes in the sintered ceramic membrane.

The solid state batteries (e.g., lithium-ion solid state electrolyte batteries, sodium-ion solid state electrolyte batteries, or magnesium-ion solid state electrolyte batteries) comprise current collector(s). The batteries have a cathode-side (first) current collector disposed on the cathode-side of the porous, solid-state electrolyte material and an anode-side (second) current collector disposed on the anode-side of the porous, solid-state electrolyte material. The current collector are each independently fabricated of a metal (e.g., aluminum, copper, or titanium) or metal alloy (aluminum alloy, copper alloy, or titanium alloy).

The solid-state batteries (e.g., lithium-ion solid state electrolyte batteries, sodium-ion solid state electrolyte batteries, or magnesium-ion solid state electrolyte batteries) may comprise various additional structural components (such as bipolar plates, external packaging, and electrical contacts/leads to connect wires. In an embodiment, the battery further comprises bipolar plates. In an embodiment, the battery further comprises bipolar plates and external packaging, and electrical contacts/leads to connect wires. In an embodiment, repeat battery cell units are separated by a bipolar plate.

The cathode material (if present), the anode material (if present), the SSE material, the cathode-side (first) current collector (if present), and the anode-side (second) current collector (if present) may form a cell. In this case, the solid-state, ion-conducting battery comprises a plurality of cells separated by one or more bipolar plates. The number of cells in the battery is determined by the performance requirements (e.g., voltage output) of the battery and is limited only by fabrication constraints. For example, the solid-state, ion-conducting battery comprises 1 to 500 cells, including all integer number of cells and ranges therebetween.

In an embodiment, the ion-conducting, solid-state battery or battery cell has one planar cathode and/or anode-electrolyte interface or no planar cathode and/or anode-electrolyte interfaces. In an embodiment, the battery or battery cell does not exhibit solid electrolyte interphase (SEI).

The following examples are presented to illustrate the present disclosure. They are not intended to limiting in any manner.

### Example 1

The following is an example describing the solid-state lithium ion batteries of the present disclosure and making same.

The flammable organic electrolytes of conventional batteries can be replaced with non-flammable ceramic-based solid-state electrolytes (SSEs) that exhibit, for example, room temperature ionic conductivity of ≥10⁻³ Scm⁻¹ and electrochemical stability up to 6V. This can further allow replacement of typical LiCoO₂ cathodes with higher voltage cathode materials to increase power/energy densities. Moreover, the integration of these ceramic electrolytes in a planar stacked structure with metal current collectors will provide battery strength.

Intrinsically safe, robust, low-cost, high-energy-density all-solid-state Li-ion batteries (SSLiBs), can be fabricated by integrating high conductivity garnet-type solid Li ion electrolytes and high voltage cathodes in tailored micro/nano-structures, fabricated by low-cost supported thin-film ceramic techniques. Such batteries can be used in electric vehicles.

Li-garnet solid-state electrolytes (SSEs) that have, for example, a room temperature (RT) conductivity of ˜10⁻³ Scm⁻¹ (comparable to organic electrolytes) can be used. The can be increased to ˜10⁻² Scm⁻¹ by increasing the disorder of the Li-sublattice. The highly stable garnet SSE allows use of Li₂MMn₃O₈ (M=Fe, Co) high voltage (˜6V) cathodes and Li metal anodes without stability or flammability concerns.

Known fabrication techniques can be used to form electrode supported thin-film (˜10 μm) SSEs, resulting in an area specific resistance (ASR) of only ˜0.01 Ωcm⁻². Use of scalable multilayer ceramic fabrication techniques, without need for dry rooms or vacuum equipment, provide dramatically reduced manufacturing cost.

Moreover, the tailored micro/nanostructured electrode support (scaffold) will increase interfacial area, overcoming the high impedance typical of planar geometry solid-state lithium ion batteries (SSLiBs), resulting in a C/3 IR drop of only 5.02 mV. In addition, charge/discharge of the Li-anode and Li₂Mn₃O₈ cathode scaffolds by pore-filling provides high depth of discharge ability without mechanical cycling fatigue seen with typical electrodes.

At ˜170 μm/repeat unit, a 300V battery pack would only be <1 cm thick. This form factor with high strength due to Al bipolar plates allows synergistic placement between framing elements, reducing effective weight and volume. Based on the SSLiB rational design, targeted SSE conductivity, high voltage cathode, and high capacity electrodes the expected effective specific energy, including structural bipolar plate, is ˜600 Wh/kg at C/3. Since bipolar plates provide strength and no temperature control is necessary this is essentially a full battery pack specification other than the external can. The corresponding effective energy density is 1810 Wh/L.

All the fabrication processes can be done with conventional ceramic processing equipment in ambient air without the need of dry rooms, vacuum deposition, or glove boxes, dramatically reducing cost of manufacturing.

For the all solid-state battery with no SEI or other performance degradation mechanisms inherent in current state-of-art Li-batteries, the calendar life of the instant battery is expected to exceed 10 years and cycle life is expected to exceed 5000 cycles.

Solid-state Li-garnet electrolytes (SSEs) have unique properties for SSLiBs, including room temperature (RT) conductivity of ˜10⁻³ Scm⁻¹ (comparable to organic electrolytes) and stability to high voltage (˜6V) cathodes and Li-metal anodes without flammability concerns.

Use of SSE oxide powders can enable use of low-cost scalable multilayer ceramic fabrication techniques to form electrode supported thin-film (˜10 μm) SSEs without need for dry rooms or vacuum equipment, as well as engineered micro/nano-structured electrode supports to dramatically increase interfacial area. The later will overcome the high interfacial impedance typical of planar geometry SSLiBs, provide high depth of discharge ability without mechanical cycling fatigue seen with typical electrodes, as well as avoid SEI layer formation.

The SSE scaffold/electrolyte/scaffold structure will also provide mechanical strength, allowing for the integration of structural metal interconnects (bipolar plates) between planar cells, to improve strength, weight, thermal uniformity, and form factor. The resulting strength and form factor provides potential for the battery pack to be load bearing.

Highly Li⁺ conducting and high voltage stable garnet type solid electrolytes can be made by doping specific cations for Ta and Zr in Li₅La₃Ta₂O₁₂, Li₆La₂BaTa₂O₁₂ and Li₇La₃Zr₂O₁₂, to extend RT conductivity from ˜10⁻³ to ˜10⁻² Scm⁻¹. Compositions having desirable conductivity, ionic transference number, and electrochemical stability up to 6V against elemental Li can be determined.

Electrode supported thin film SSEs can be fabricated. Submicron SSE powders and SSE ink/paste formulations thereof can be made. Tape casting, colloidal deposition, and sintering conditions can be developed to prepare dense thin-film (˜10 μm) garnet SSEs on porous scaffolds.

Cathode and anode can be integrated. Electrode-SSE interface structure and SSE surface can be optimized to minimize interfacial impedance for targeted electrode compositions. High voltage cathode inks can be made to fabricate SSLiBs with high voltage cathode and Li-metal anode incorporated into the SSE scaffold. The SSLiB electrochemical performance can be determined by measurements including CV, energy/power density and cycling performance.

Stacked multi-cell SSLiBs with Al/Cu bipolar plates can be assembled. Energy/power density, cycle life, and mechanical strength as a function of layer thicknesses and area for the stacked multi-cell SSLiBs can be determined.

Li-Stuffed Garnets SSEs. Conductivity of Li-Garnet SSEs can be improved doping to increase the Li content (“stuffing”) of the garnet structure. Li-stuffed garnets exhibit desirable physical and chemical properties for SSEs including:
RT bulk conductivity (˜10⁻³ S/cm) for cubic Li₇La₃Zr₂O₁₂.
High electrochemical stability for high voltage cathodes (up to 6 V), about 2 V higher than current organic electrolytes and about 1 V higher than the more popular LiPON.
Excellent chemical stability in contact with elemental and molten Li anodes up to 400° C.
Li⁺ transference number close to the maximum of 1.00, which is important to battery cycle efficiency, while typical polymer electrolytes are only ˜0.35.
Wide operating temperature capability, electrical conductivity that increases with increasing temperature reaching 0.1 Scm⁻¹ at 300° C., and maintains appreciable conductivity below 0° C. In contrast, polymer electrolytes are flammable at high temperature
Synthesizable as simple mixed oxide powders in air, hence easy scale up for bulk synthesis.

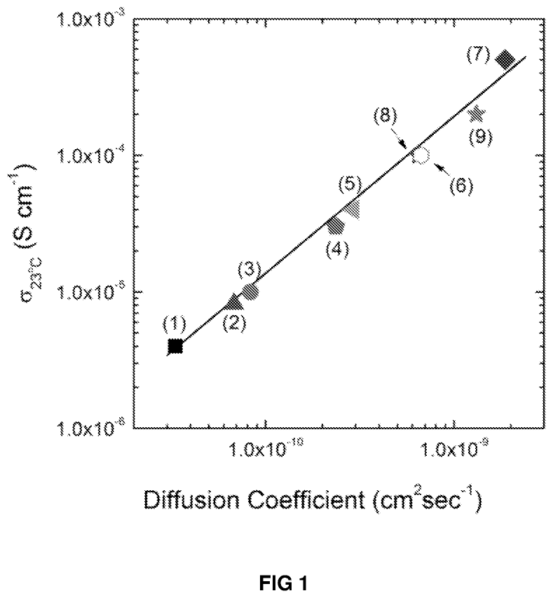

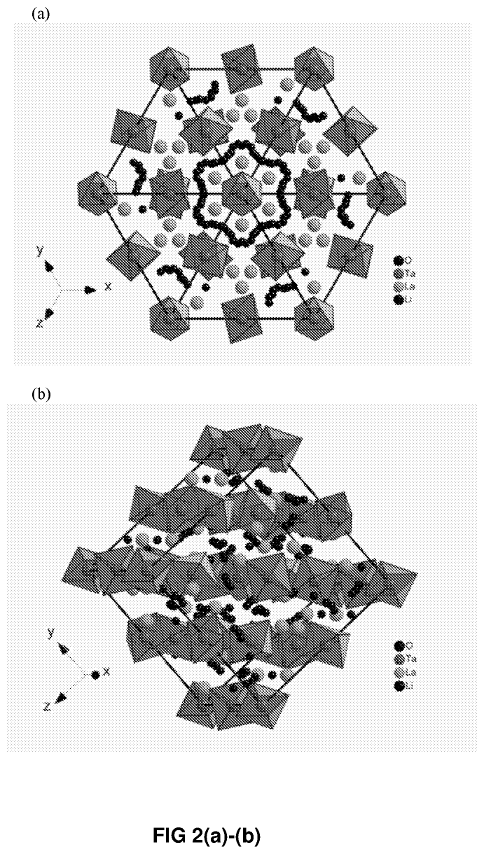

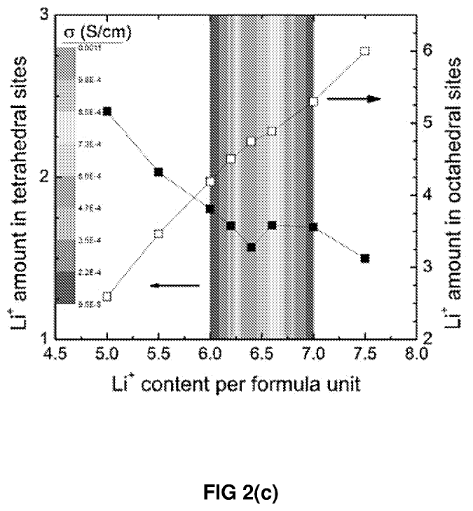

Li⁺ conductivity of garnet SSEs can be further increased. The Li ion conductivity of garnet is highly correlated to the concentration of Li⁺ in the crystal structure. FIG. 1 shows the relationship between the Li⁺ conductivity and diffusion coefficient for various Li-stuffed garnets. The conductivity increases with Li content, for example, the cubic Li₇-phase (Li₇La₃Zr₂O₁₂) exhibits a RT conductivity of 5×10⁻⁴ S/cm. However, conductivity also depends on synthesis conditions, including sintering temperature. The effects of composition and synthesis method can be determined to achieve a minimum RT conductivity of ˜10⁻³ S/cm for the scaffold supported SSE layer. It is expected the RT conductivity can be increased to ˜10⁻² S/cm through doping to increase the disorder of the Li sub lattice. Ionic conduction in the garnet structure occurs around the metal-oxygen octahedron, and site occupancy of Li ions in tetrahedral vs. octahedral sites directly controls the Li ion conductivity (FIG. 2). For example, in Li₅La₃Ta₂O₁₂, about 80% of Li ions occupy the tetrahedral sites while only 20% occupy octahedral sites. Increasing the Li⁺ concentration at octahedral sites while decreasing occupancy of the tetrahedral sides has been shown to result in an order of magnitude increase in ionic conductivity (FIG. 2b). Smaller-radii metal ions (e.g., Y3⁺), which are chemically stable in contact with elemental Li and isovalent with La, can be doped to develop a new series of garnets: Li₆BaY₂M₂O₁₂, Li_{6.4}Y₃Zr_{1.6}Ta_{0.6}O₁₂, Li₇Y₃Zr₂O₁₂, and their solid solutions; to increase ionic conductivity. The enthalpy of formation of Y₂O₃ (˜1932 kJ/mol) is lower than that of La₂O₃ (˜1794 kJ/mol), hence, doping Y for La will increase Y—O bond strength and weaken Li—O bonds. Thus increasing Li⁺ mobility due to weaker lithium to oxygen interaction energy. Further, it is expected that Y will provide a smoother path for ionic conduction around the metal oxygen octahedral due to its smaller ionic radius (FIG. 2a).

In another approach, we can substitute M²⁺ cations (e.g., Zn²⁺, a 3d° cation known to form distorted metal-oxygen octahdera) for the M⁵⁺ sites in Li₆BaY₂M₂O₁₂. ZnO is expected to play a dual role of both further increasing the concentration of mobile Li ions in the structure and decreasing the final sintering temperature. Each M²⁺ will add three more Li⁺ for charge balance and these ions will occupy vacant Li⁺ sites in the garnet structure. Thus, further increase Li⁺ conduction can be obtained by modifying the garnet composition to control the crystal structure, Li-site occupancy, and minimize the conduction path activation energy.

Due to the ceramic powder nature of Li-garnets, SSLiBs can be fabricated using conventional fabrication techniques. This has tremendous advantages in terms of both cost and performance. All the fabrication processes can be done with conventional ceramic processing equipment in ambient air without the need of dry rooms, vacuum deposition, or glove boxes, dramatically reducing cost of manufacturing.

The SSLiBs investigated to date suffer from high interfacial impedance due to their low surface area, planar electrode/electrolyte interfaces (e.g., LiPON based SSLiBs). Low area specific resistance (ASR) cathodes and anodes can be achieved by integration of electronic and ionic conducting phases to increase electrolyte/electrode interfacial area and extend the electrochemically active region farther from the electrolyte/electrode planar interface. It is expected that modification of the nano/microstructure of the electrolyte/electrode interface (for example, by colloidal deposition of powders or salt solution impregnation) can reduce overall cell area specific resistance (ASR), resulting in an increase in power density relative to identical composition and layer thickness cells. These same advances can be applied to decrease SSLiB interfacial impedance. The SSLiB will be made by known fabrication techniques Low-cost, high-speed, scalable multi-layer ceramic processing can be used to fabricate supported thin-film (˜10 μm) SSEs on tailored nano/micro-structured electrode scaffolds. ˜50 and 70 μm tailored porosity (nano/micro features) SSE garnet support layers (scaffolds) can be tape cast, followed by colloidal deposition of a ˜10 μm dense garnet SSE layer and sintering. The resulting pinhole-free SSE layer is expected to be mechanically robust due to support layers and have a low area specific resistance ASR, for example, only ˜0.01 ΩCm². Li₂MMn₃O₈ will be screen printed into the porous cathode scaffold and initial Li-metal will be impregnated in the porous anode scaffold (FIG. 3). For example, Li₂(Co,Fe)Mn₃O₈ high voltage cathodes can be prepared in the form of nano-sized powders using wet chemical methods. The nano-sized electrode powders can be mixed with conductive materials such as graphene or carbon black and polymer binder in NMP solvent. Typical mass ratio for cathode, conductive additive or binder is 85%: 10%: 5% by weight. The slurry viscosity can be optimized for filling the porous SSE scaffold, infiltrated in and dried. An Li-metal flashing of Li nanoparticles may be infiltrated in the porous anode scaffold or the Li can be provided fully from the cathode composition so dry room processing can be avoided.

Another major advantage of this structure is that charge/discharge cycles will involve filling/emptying of the SSE scaffold pores (see FIG. 3), rather than intercalating and expanding carbon anode powders/fibers. As a result there will be no change in electrode dimensions between charged and discharged state. This is expected to remove both cycle fatigue and limitations on depth of discharge, the former allowing for greater cycle life and the later for greater actual battery capacity.

Moreover, there will be no change in overall cell dimensions allowing for the batteries to be stacked as a structural unit. Light-weight, ˜40 micron thick Al plates will serve not only as current collectors but also provide mechanical strength. ˜20 nm of Cu can be electrodeposited on the anode side for electrochemical compatibility with Li. The bipolar current collector plates can be applied before the slurry is fully dried and pressed to improve the electrical contact between bipolar current collector and the electrode materials.

Compared to current LiBs with organic electrolytes, the SSLiB with intrinsically safe solid state chemistry is expected to not only increase the specific energy density and decrease the cost on the cell level, but also avoid demanding packing level and system level engineering requirements. High specific energy density at both cell and system level can be achieved, relative to the state-of-the-art, by the following:
Stable electrochemical voltage window of garnet SSE allows for high voltage cathodes resulting in high cell voltage (˜6 V).
Porous SSE scaffold allows use of high specific capacity Li-metal anode.
Porous 3-dimensionally networked SSE scaffolds allows electrode materials to fill volume with a smaller charge transfer resistance, increasing mass percentage of active electrode materials.
Bipolar plates will be made by electroplating ˜200 Å Cu on ˜40 μm Al plates. Given the 3× lower density of Al vs. Cu the resulting plate will have same weight as the sum of the ˜10 μm Al and Cu foils used in conventional batteries. However, with 3× the strength (due to ˜9× higher strength-to-weight ratio of Al vs. Cu).
The repeat unit (SSLiB/bipolar plate) will then be stacked in series to obtain desired battery pack voltage (e.g., fifty 6V SSLiBs for a 300V battery pac would be <1 cm thick).
Thermal and electrical control/management systems are not needed as there is no thermal runaway concern.
The proposed intrinsically safe SSLiBs also drastically reduces mechanical protection needs.

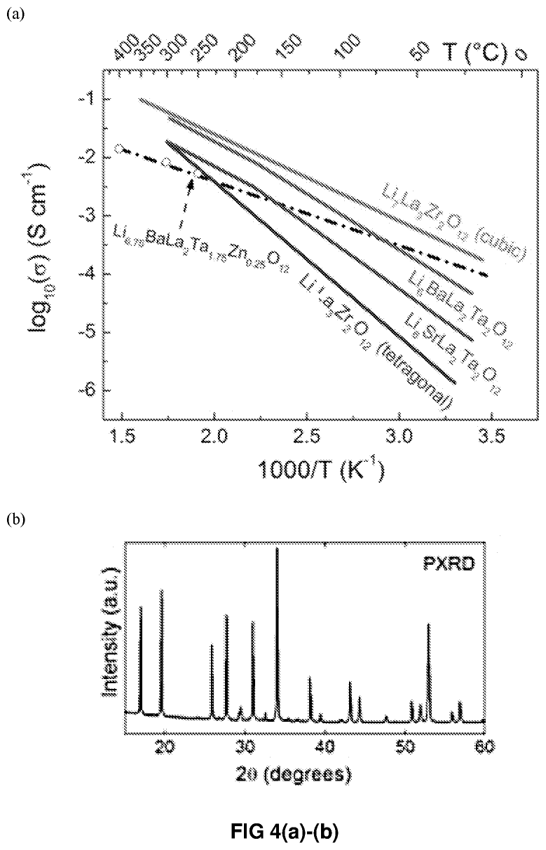

The energy density is calculated from component thicknesses of device structure (FIG. 4) normalized to 1 cm² area (see data in Table 1). The estimated SSE scaffold porosity is 70% for the cathode and 30% for the anode. The charge/capacity is balanced for the anode and cathode by: m_{Li}×C_{Li}=m_{LMFO}×C_{LMFO} where LFMO stands for Li₂FeMn₃O₈. Therefore, the total mass (cathode-scaffold/SSE/scaffold and bipolar plate) is calculated to be 50.92 mg per cm² area. Note it is our intent to fabricate charged cells with all Li in cathode to avoid necessity of dry room. Thus, anode-scaffold would be empty of Li metal for energy density calculations.

TABLE 1
Material parameters for energy density calculation

| | Density | mass per | Capacity | Voltage |
|---|---|---|---|---|
| Material | (g/cm3) | cm2 (mg) | (mA/g) | (Vs. Li) (V) |
| Cathode LFMO | 3.59 | 17.00 | 300 | 6 |
| Anode Li | 0.54 | 0 | 3800 | 0 |
| SSE | 5.00 | 27.5 | N/A | N/A |
| Al | 2.70 | 5.40 | N/A | N/A |
| Cu | 8.69 | 0.02 | N/A | N/A |
| Carbon additive | 1.00 | 1.00 | N/A | N/A |
| Cell Total | | 50.92 | | |

The corresponding total energy is Eₜₒₜ=C×V=5.13 mAh×6 V=30.78 mWh. The total volume is 1.7×10⁻⁵ L for 1 cm² area. Therefore, the theoretical effective specific energy, including structural bipolar plate, is ˜603.29 Wh/kg. As calculated below, the overpotential at C/3 is negligible compared with the cell voltage, leading to an energy density at this rate close to theoretical. Since the bipolar plate provides strength and no temperature control is necessary this is essential the full battery pack specification other than external can. (In contrast, state-of-art LiBs have a ˜40% decrease in energy density from cell level to pack level.) The corresponding effective energy density of the complete battery pack is ˜1810 Wh/L.

A desirable rate performance is expected with the SSLiBs due to 3-dimensional (3D) networked scaffold structures, comparable to organic electrolyte based ones, and much better than traditional planar solid state batteries. The reasons for this include the following:
Porous SSE scaffolds provide extended 3D electrode-electrolyte interface, dramatically increasing the surface contact area and decreasing the charge-transfer impedance.
Use of SSE having a conductivity of 10⁻³-10⁻² S/cm in electrode scaffolds to provide continuous Li⁺ conductive path.
Use of high aspect ratio (lateral dimension vs. thickness) graphene in electrode pores to provide continuous electron conductive path.

To calculate the rate performance, the overpotential of SSLiB, shown in FIG. 3, was estimated, including electrolyte impedance (Z_{SSE}) and electrode-electrolyte-interface impedance (Z_{interface}).

The porous SSE scaffold achieves a smaller interfacial impedance by: 1/Z_{interface}=S*Gs, where S is the interfacial area close to the porous SSE and Gs is the interfacial conductance per specific area. The interfacial impedance is expected to be small since the porous SSE results in a large electrode-electrolyte interfacial area. For ion transport impedance through the entire SSE structure: ZSSE=Zcathode−scaffold+Zdense−SSE+Zanode−scaffold; and Z=(ρL)/(A*(1−ε)), where p=100 Ω cm, L is thickness (FIG. 3), A is 1 cm², and F is porosity (70% for the cathode scaffold, 50% for the anode scaffold and 0% for the dense SSE layer). Therefore, Zcathode−scaffold=2.3 Ohm/cm², Zdense−SSE=0.01 Ohm/cm², and Zanode−scaffold=1 Ohm/cm²; resulting in Ztotal=3.31 Ohm/cm². At C/3, the current density=1.71 mA/cm² and the voltage drop is 5.02 mV/cm², which is negligible compared with a 6 V cell voltage.

Desirable cycling performance is expected due to the following advantages:
No structural challenges associated with intercalating and de-intercalating Li due to filling of 3D porous structure.
Excellent mechanical and electrochemical electrolyte-electrode interface stability due to 3D porous SSE structure.
No SEI formation inherent in current state-of-art LiBs, which consumes electrolyte and increase cell impedance.
NoLi dendrite formation (problematic for LiBs with Li anodes) due to dense ceramic SSE. Therefore, the calendar life should easily exceed 10 years and the cycle life should easily exceed 5000 cycles.

The SSLiB is an advancement in battery materials and architecture. It can provide the necessary transformational change in battery performance and cost to accelerate vehicle electrification. As a result it can improve vehicle energy efficiency, reduce energy related emissions, and reduce energy imports.

FIG. 4 shows the conductivity for Li garnets, including Li_{6.75}BaLa₂Ta_{1.75}Zn_{0.25}O₁₂. It is expected that the lower activation energy of this composition will provide a path to achieve RT conductivity of ˜10⁻² Scm⁻¹ when similar substitutions are made in Li₇La₃Zr₂O₁₂.

Since garnet SSEs can be synthesized as ceramic powders (unlike LiPON) high-speed, scalable multilayer ceramic fabrication techniques can be used to fabricate supported thin-film (˜10 μm) SSEs on tailored nano/micro-structured electrode scaffolds (FIG. 3). Tape casting 50 and 70 μm tailored porosity (nano/micro features) SSE support layers, followed by colloidal deposition of a ˜10 μm dense SSE layer and sintering can be used. The resulting pinhole-free SSE layer will be mechanically robust due to support layers and have a low area specific resistance ASR, of only ˜0.01 Ωcm².

The ˜6.0 volt cathode compositions (Li₂MMn₃O₈, M=Fe, Co) have been synthesized. These can be combined with SSE scaffold & graphene to increase ionic and electronic conduction, respectively, as well as to reduce interfacial impedance. Li₂MMn₃O₈ can be screen printed into the porous cathode scaffold and Li-metal impregnated in the porous anode scaffold.

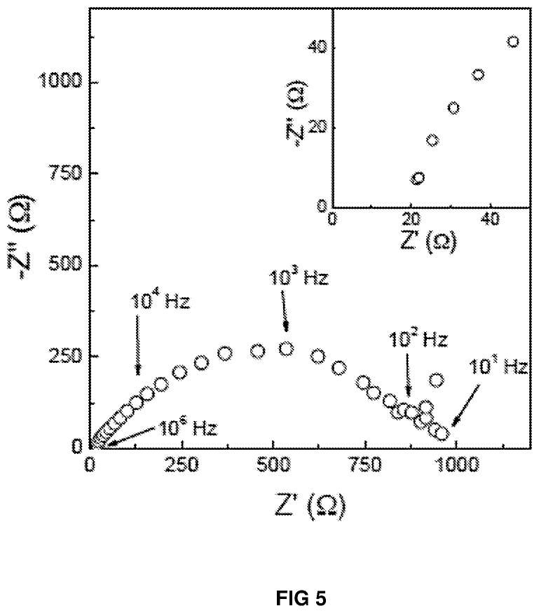

FIG. 5 shows EIS results for a solid state Li cell tested using the Li infiltrated porous scaffold anode, supporting a thin dense SSE layer, and screen printed LiFePO₄ cathode. The high-frequency intercept corresponds to the dense SSE impedance and the low frequency intercept the entire cell impedance.

Bipolar plates can be fabricated by electroplating ˜200 Å Cu on ˜40 μm Al. Given the 3× lower density of Al vs. Cu the resulting plate will have same weight as the sum of the ˜10 μm Al and Cu foils used in conventional batteries. However, with 3× the strength (due to ˜9× higher strength-to-weight ratio of Al vs. Cu). Increases in strength can be achieved by simply increasing Al plate thickness with negligible effect on gravimetric and volumetric energy density or cost. The repeat unit (SSLiB/bipolar plate) can be stacked in series to obtain desired battery pack voltage (e.g., fifty 6V SSLiBs for a 300V battery pack would be <1 cm thick).

In terms of performance and cost:
The energy density of SSLiBs shown in FIG. 3 is ˜600 Wh/kg based on a 6 V cell. A Li₂FeMn₃O₈ cathode has a voltage of 5.5 V vs. Li. With this cathode, energy density of 550 Wh/kg can be achieved.
The calculation for energy density in Table 3 does not include packing for protection of thermal runaway and mechanical damage as this is not necessary for SSLiBs. If 20% packaging is included, the total energy density is still 500 Wh/kg.
The voltage drop of ˜5 mV for C/3 was based on SSE with an ionic conductivity of ˜10⁻² S/cm (using the porous SSE scaffold with dense SSE layer and corresponding small interfacial charge transfer resistance). At an ionic conductivity of 5×10⁻¹ S/cm, the voltage drop for C/3 rate is only ˜0.1 V, which is significantly less than the cell voltage of 6 V.
The materials cost for SSLiBs is only ˜50 $/KWh due to the high SSLiB energy density and corresponding reduction in materials to achieve the same amount of energy. The non-material manufacturing cost is expected, without the need of dry room, for our SSLiBs to be lower than that for current state-of-art LiBs.

The SSE materials can be synthesized using solid state and wet chemical methods. For example, corresponding metal oxides or salts can be mixed as solid-state or solution precursors, dried, and synthesized powders calcined between 700 and 1200° C. in air to obtain phase pure materials. Phase purity can be determined as a function of synthesis method and calcining temperature by powder X-ray diffraction (PXRD, D8, Bruker, Cuka). The structure can be determined by Rietveld refinements. Using structural refinement data, the metal-oxygen bond length and Li—O bond distance can be estimated to determine role of dopant in garnet structure on conductivity. In-situ PXRD can be performed to identify any chemical reactivity between the garnet-SSEs and the Li₂(Fe,Co)Mn₃O₈ high voltage cathodes as a function of temperature. The Li ion conductivity can be determined by electrochemical impedance spectroscopy (EIS-Solartron 1260) and DC (Solartron Potentiostat 1287) four-point methods. The electrical conductivity can be investigated using both Li⁺ blocking Au electrodes and reversible elemental Li electrodes. The Li reversible electrode measurement will provide information about the SSE/electrode interface impedance in addition to ionic conductivity of the electrolyte, while the blocking electrode will provide information as to any electronic conduction (transference number determination). The concentration of Li⁺ and other metal ions can be determined using inductively coupled plasma (ICP) and electron energy loss spectroscopy (EELS) to understand the role of Li content on ionic conductivity. The actual amount of Li and its distribution in the three different crystallographic sites of the garnet structure can be important to improve the conductivity and the concentration of mobile Li ions will be optimized to reach the RT conductivity value of 10² S/cm.

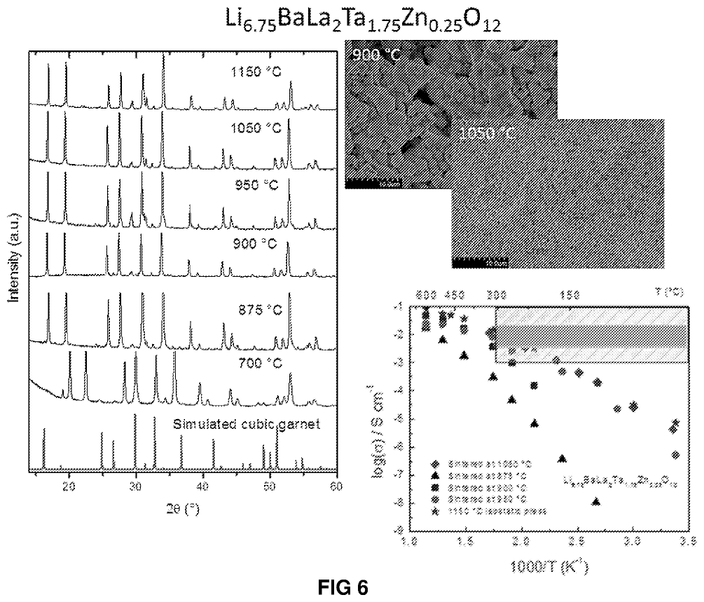

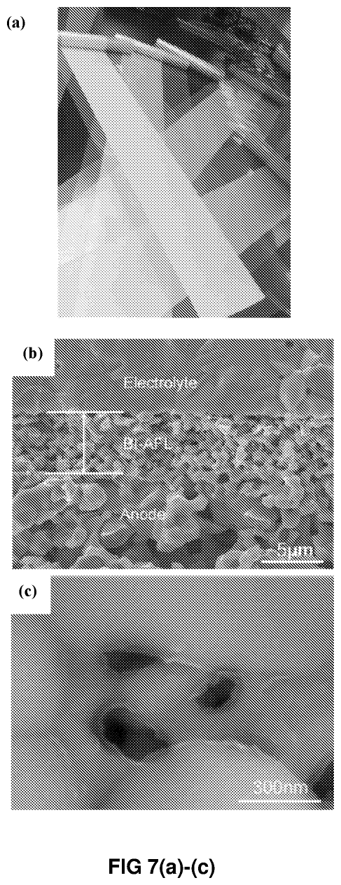

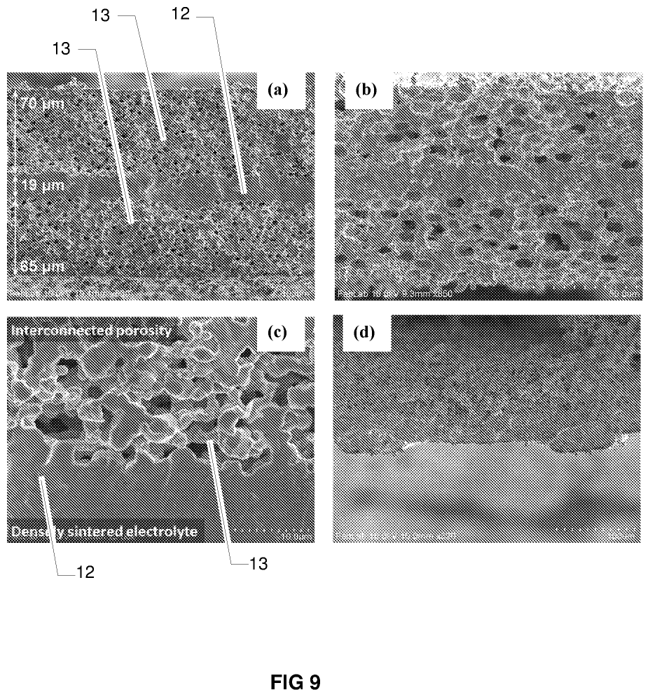

Sintering of low-density Li-garnet samples is responsible for a lot of the literature variability in conductivity (e.g., as shown in FIG. 6). The primary issue in obtaining dense SSEs is starting with submicron (or nano-scale) powders. By starting with nano-scale powders it is expected that the sintering temperature necessary to obtain fully dense electrolytes can be lowered. The nanoscale electrolyte and electrode powders can be made using co-precipitation, reverse-strike co-precipitation, glycine-nitrate, and other wet synthesis methods. These methods can be used to make desired Li-garnet compositions and to obtain submicron SSE powders. The submicron SSE powders can then be used in ink/paste formulations by mixing with appropriate binders and solvents to achieve desired viscosity and solids content. Dense thin-film (˜10 μm) garnet SSEs on porous SSE scaffolds (e.g., FIG. 9b) can be formed by tape casting (FIG. 7a), colloidal deposition, and sintering. The methods described can be used to create nano-dimensional electrode/electrolyte interfacial areas to minimize interfacial polarization (e.g., FIG. 7c). The symmetric scaffold/SSE/scaffold structure shown in FIG. 3 can be achieved by laminating a scaffold/SSE layer with another scaffold layer in the green state (prior to sintering) using a heated lamination press.

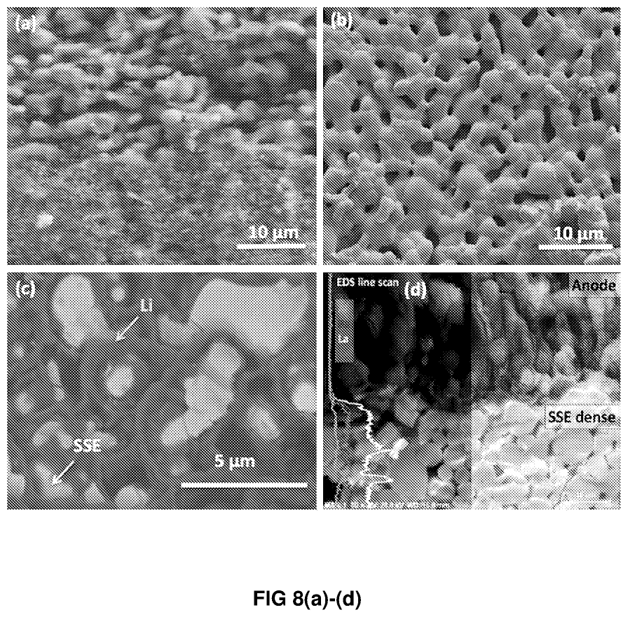

Cathode and anode integration. Nanosized (˜100 nm) cathode materials Li₂MMn₃O₈ (M=Fe, Co) can be synthesized. With the SSE that is stable up to 6V, a specific capacity of 300 mAh/g is expected. Slurries of cathode materials can be prepared by dispersing nanoparticles in N-Methyl-2-pyrrolidone (NMP) solution, with 10% (weight) carbon black and 5% (weight) Polyvinylidene fluoride (PVDF) polymer binder. The battery slurry can be applied to cathode side of porous SSE scaffold by drop casting. SSE with cathode materials can be heated at 100° C. for 2 hours to dry out the solvent and enhance electrode-electrolyte interfacial contact. Additional heat processing may be needed to optimize the interface. The viscosity of the slurry will be controlled by modifying solids content and binder/solvent concentrations to achieve a desired filling. The cathode particle size can be changed to control the pore filling in the SSE. In an example, all of the mobile Li will come from cathode (the anode SSE scaffold may be coated with a thin layer of graphitic material by solution processing to “start-up” electronic conduction in the cell). In another example, a thin layer of Li metal will be infiltrated and conformally coated inside anode SSE scaffold. Mild heating (˜400° C.) of Li metal foil or commercial nanoparticles can be used to melt and infiltrate the Li. Excellent wetting between Li-metal and SSE is important and was obtained by modifying the surface of the SSE scaffold (FIG. 8). To fill the SSE pores in the anode side with highly conductive graphitic materials, a graphene dispersion can be prepared by known methods. For example, 1 mg/mL graphene flakes can be dispersed in water/IPA solvent by matching the surface energy between graphene and the mixed solvent. Drop coating can be used to deposit conductive graphene with a thickness of ˜10 nm inside the porous SSE anode scaffold. After successfully filling the scaffold pores, the cell can be finished with metal current collectors. Al foil can be used for the cathode and Cu foil for the anode. Bipolar metals can be used for cell stacking and integration. To improve the electrical contact between electrodes and current collectors, a thin graphene layer may be applied. The finished device may be heated up to 100° C. for 10 minutes to further improve the electrical contact between the layers. The electrochemical performance of the SSLiB can be evaluated by cyclic voltammetry, galvanostatic charge-discharge at different rates, electrochemical impedance spectroscopy (EIS), and cycling performance at C/3. EIS can be used in a broad frequency range, from 1 MHz to 0.1 mHz, to investigate the various contributions to the device impedance, and reveal the interfacial impedance between the cathode and SSE by comparing the EIS of symmetrical cells with Li-metal electrodes. The energy density, power density, rate dependence, and cycling performance of each cell, as a function of SSE, electrode, SSE-electrolyte interface, and current collector-electrode interface can be determined.

Multi-cell (2-3 cells in series) SSLiBs with Al/Cu bipolar plates can be fabricated. The energy/power density and mechanical strength can be determined as a function of layer thicknesses and area.

### Additional Disclosure, Embodiments and Examples

Further discussion of structures and methods applicable to battery cells, batteries and associated components follows.

The present disclosure provides ceramic ion-conducing structures and methods of fabricating ceramic ion-conducing structures from ceramic ion-conducting materials. Also provided are uses of ceramic ion-conducing structures.

All ranges disclosed herein are inclusive of their upper and lower limits, and include each value there between to the hundredth decimal place, and all ranges within those limits.

In an aspect, the present disclosure provides ceramic ion-conducing structures (e.g., ceramic ion-conducing materials having particular structural features and/or properties). The structures can be in the form of a single layer or multilayer structures. For example, a multilayer structure can comprise layers of ceramic ion-conducing structures, where the individual layers have the same or different porosity. The ceramic ion-conducing structures can be ion-conducting electrolyte materials (e.g., solid-state electrolyte materials). The ion-conducing ceramic structures can be formed by a method (e.g., a tape casting method) disclosed herein. For example, a ceramic ion-conducing structure is formed by a method disclosed herein.

A ceramic ion-conducting structure can be a layer. For example, a layer has a dimension (e.g., a thickness perpendicular to the longest dimension of the material) of 1 μm to 200 μm, including all 0.1 micron values and ranges therebetween.

The ceramic ion-conducing structures can have a dense region (e.g., a dense layer) and one (e.g., a bilayer structure) or two (e.g., a triple layer structure) porous regions (e.g., porous layer(s)). The porosity of the dense region is less than that of the porous region(s).

A cathode material and/or an anode material can be disposed on a porous region of a ceramic ion-conducing structure forming a discrete cathode-material containing region and/or a discrete anode-material containing region of the ceramic ion-conducing structure. For example, each of these regions of the ceramic ion-conducting structure has, independently, a dimension (e.g., a thickness perpendicular to the longest dimension of the material) of 1 μm to 200 μm, including all 0.1 micron values and ranges therebetween.

The dense regions and porous regions described herein can be discrete dense layers and discrete porous layers. Accordingly, the ceramic ion-conducing structures can have a dense layer and one or two porous layers.

The ceramic ion-conducing structures conduct ions (e.g., lithium ions, sodium ions, or magnesium ions), for example, between the anode and cathode. The ceramic ion-conducing structures can be an ion-conducting solid-state electrolyte material for a battery or battery cell and can have a dense region (e.g., a dense layer) that is supported by one or more porous regions (e.g., porous layer(s)) (the porous region(s)/layer(s). The dense region of a ceramic ion-conducing structure is, for example, free of pin-hole defects.

The ceramic ion-conducing structures can have a dense region (e.g., a dense layer) and two porous regions (e.g., porous layers), where the porous regions are disposed on opposite sides of the dense region and cathode material is disposed on one of the porous regions and the anode material on the other porous region. If cathode material is disposed on the porous region, a conventional battery anode (e.g., a solid-state battery anode) can be formed on the opposite side of the dense region by known methods. If anode material is disposed in the porous region, a conventional battery cathode (e.g., a solid-state battery cathode) can be formed on the opposite side of the dense region.

The ceramic ion-conducing structure (e.g., a multilayer ceramic ion-conducting structure) can have a dense region. The dense region can be free of the cathode material and anode material. For example, this region has a dimension (e.g., a thickness perpendicular to the longest dimension of the material) of 1 μm to 100 μm, including all 0.1 micron values and ranges therebetween. In another example, this region has a dimension of 5 μm to 40 μm. The dense region has less than 5% porosity. In various examples, the dense region has less than 4% porosity, 3% porosity, 2% porosity, or 1% porosity. Porosity can be determined by methods known in the art. For example, porosity can be determined by electron microscopy methods.

A porous region (e.g., porous layer) of the ceramic ion-conducing structure has a porous structure. The porous structure can have microstructural features (e.g., microporosity such as, for example, micropores less than 2 nm in size (e.g., longest dimension of a pore aperture)) and/or nanostructural features (e.g., nanoporosity). For example, each porous region, independently, has a porosity of 40% to 90%, including all 0.1% values and ranges therebetween. In another example, each porous region, independently, has a porosity of 40% to 70%. Where two porous regions are present the porosity of the two layers may be the same or different. The porosity of the individual regions can be selected to, for example, accommodate processing steps (e.g., higher porosity is easier to fill with electrode material (e.g., charge storage material) (e.g., cathode)) in subsequent screen-printing or infiltration step, and achieve a desired electrode material capacity, i.e., how much of the conducting material (e.g., Li, Na, Mg) is stored in the electrode materials. The porous region (e.g., layer) provide structural support to the dense layer so that the thickness of the dense layer can be reduced, thus reducing its resistance. The porous layer also extends ion conduction of the dense phase (solid electrolyte) into the electrode layer to reduce electrode resistance both in terms of ion conduction through electrode and interfacial resistance due to charge transfer reaction at electrode/electrolyte interface, the later improved by having more electrode/electrolyte interfacial area. For example, pore size can range from 100 nm to 200 microns, including all 0.1 micron values and ranges therebetween. The pores can have any morphology. Any pore morphology can be obtained based on selection of an appropriate pore-forming material. For example, PMMA is spherical, while the graphite is flakes. Other pore-forming materials with different morphologies can be used, such as spheres, rods, flakes, or irregular shapes such as, for example, a coral-like structure and string-like particles.

The ceramic ion-conducing structures (e.g., ceramic ion-conducting layer(s)) can have a random or an ordered porous structure. For example, a porous ceramic ion-conducing layer comprises pores that connect opposing sides of the layer. For example, a porous ceramic ion-conducing structure comprising multiple layers comprises a porous layer and a dense layer and the porous layer has pores extending from an outer (exposed) surface of the porous layer to the interface between the porous layer and dense layer. The ordered porous structure can be columnar structure (e.g., a columnar structure having a tortuosity of 1). The ordered structure can comprise patterns (e.g., grids) of non-planar structures in a layer or layers of a ceramic ion-conducing structure. The ordered structure can be formed by, for example, templating or 3-D printing methods.

Dendrites can form when lithium is cycled to the anode side. If dendrites of lithium form, they must not be able to protrude through the dense layer and contact the other electrode. It is desirable that a ceramic ion-conducing structure is hard enough and dense layer dense enough to prevent dendrites from propagating across the structure. It is desirable that a ceramic ion-conducing structure not allow dendrites to form (form dendrites) during cycling. Accordingly, in an example, the ceramic ion-conducing material (or a ceramic ion-conducting structure) does not have observable dendrites (e.g., lithium dendrites). Dendrites can be observed by methods known in the art. For example, the presence or absence of dendrites is determined by electron microscopy methods.

The ceramic ion-conducting structures can be in the form of a layer or layers (e.g., a layer or layers formed by tape casting). It is desirable that cells comprising one or more of the layers be stacked compactly and without flexing to the point of breaking. This is dependent on material and cell length, width and thickness dimensions. It is desirable that individual layers be flat. For example, a layer has a maximum P−V Error of 325 μm, where P−V Error=Peak height −Valley height. In various examples, a layer has a maximum P−V Error of 350 μm, 375 μm, 400 μm, 425 μm, 450 μm, 475 μm, or 500 μm.

The ceramic ion-conducing structure can comprise a ceramic ion-conducting material (e.g., a solid-state, ion-conducting electrolyte material). The ceramic ion-conducing structure can comprise a solid-state electrolyte (SSE), lithium-containing material. For example, the solid-state electrolyte, lithium-containing material is a lithium-garnet SSE material.

The ceramic ion-conducing material can be a Li-garnet material comprising cation-doped Li₅ La₃M′₂O₁₂, cation-doped Li₆La₂BaTa₂O₁₂, cation-doped Li₇La₃Zr₂O₁₂, and cation-doped Li₆BaY₂M′₂O₁₂. The cation dopants are calcium, barium, yttrium, zinc, or combinations thereof and M′ is Nb, Zr, Ta, or combinations thereof.

For example, the Li-garnet material comprises Li₅La₃Nb₂O₁₂, Li₅La₃Ta₂O₁₂, Li₇La₃Zr₂O₁₂, Li₆La₂SrNb₂O₁₂, Li₆La₂BaNb₂O₁₂, Li₆La₂SrTa₂O₁₂, Li₆La₂BaTa₂O₁₂, Li₇Y₃Zr₂O₁₂, Li_{6.4} Y₃Zr_{1.4}Ta_{0.6}O₁₂, Li_{6.5}La_{2.5}Ba_{0.5}TaZrO₁₂, Li₆BaY₂M¹₂O¹₂, Li₇Y₃Zr₂O₁₂, Li_{6.75}La_{2.75}Ca_{0.25}Zr_{1.5}Nb_{0.5}O₁₂, Li_{6.75}BaLa₂Nb_{1.75}Zn_{0.25}O₁₂, or Li_{6.75}BaLa₂Ta_{1.75}Zn_{0.25}O₁₂. For example, the Li-garnet material is Li₇La_{2.75}Ca_{0.25}Zr_{1.75}Nb_{0.25}O₁₂.

The ceramic ion-conducing structure can comprise a sodium-containing, solid-state electrolyte material. For example, the ceramic ion-conducing material can be Na₃ZrSi₂PO₁₂ (NASICON) or beta-alumina.

The ceramic ion-conducing structure can comprise a solid-state electrolyte, magnesium-containing material. For example, the magnesium ion-conducting electrolyte material is MgZr₄P₆O₂₄.

Standard x-ray diffraction analysis techniques may be performed to identify the crystal structure and phase purity of the ceramic ion-conducting structures.

In an aspect the present disclosure provides methods of fabricating ceramic-ionic conducing structures. The methods are based on particular slurry formulation methods and/or particular sintering methods. The methods can be tape casting methods.

A method of fabricating ceramic ionic-conducing structures can comprise forming a slurry. The slurry can be used in a tape casting method. The order of addition of components (starting materials) during formation of the slurry and/or milling time(s) can be critical.

For example, a slurry for dense ceramic ionic-conducing structures (e.g., a dense layer) can be formed by i) adding solvent(s) (e.g., isopropanol and toluene) to a dispersant (e.g., fish oils such as, for example, blown fish oils (e.g., ‘Blown Menhaden fish oil, Z-3’ from Tape Casting Warehouse, Inc.)) and mixing until the dispersant is dissolved in the solvent(s), ii) optionally, adding a sintering facilitating material (e.g., Al₂O₃) (which can increase conductivity) (e.g., at 0.1 to 0.2 mole per mole of ceramic material), and iii) adding the ceramic material. The sintering facilitating material, if present, and ceramic material can be added in any order. This mixture is milled (first milling) for 1 to 47 hours, including all 0.1 hour values and range therebetween. In various examples, the mixture is milled for at least 1 hour, at least 10 hours, or at least 24 hours. After the first milling step, plasticizer(s) (optionally, plasticizer(s) dissolved in a solvent) (e.g., BBP) is/are added to the mixture of dispersant, solvent(s), sintering facilitating material, if present, and ceramic material). After addition of plasticizer(s), binder(s) (optionally, binder(s) dissolved in a solvent) (e.g., PVB) is/are added. Optionally, solvent(s) is/are added after addition of the binder(s). This mixture is milled (second milling) for 12 to 48 hours, including all 0.1 hour values and range therebetween. Additional mixing (e.g., by agitation) can be carried out after addition (e.g., to provide a homogenous solution or uniform suspension) of any of the starting materials. For example, steps described in this example are carried out in the stated order and/or without any additional steps.

For example, a slurry for porous ceramic ionic-conducing structures (e.g., a porous layer) can be formed by i) adding one or more solvents to a dispersant (e.g., fish oils such as, for example, blown fish oils (e.g., ‘Blown Menhaden fish oil, Z-3’ from Tape Casting Warehouse, Inc.)) and mixing until the dispersant is dissolved in the solvent, ii) optionally, adding a sintering facilitating material (such as Al₂O₃) (which can increase conductivity), iii) optionally, adding a pore-forming material (e.g., PMMA or graphite), and iv) adding the ceramic material. The sintering facilitating material, if present and ceramic material can be added in any order. This mixture is milled for 1 to 47 hours, including all 0.1 hour values and range therebetween. For example, the mixture is milled for at least 1 hour or at least 10 hours. After milling, plasticizer(s) (optionally, plasticizer(s) dissolved in a solvent) (e.g., BBP) is/are added to the mixture of dispersant, solvent(s), sintering facilitating material, if present, and ceramic material). After addition of plasticizer(s), binder(s) (optionally, binder(s) dissolved in a solvent) (e.g., PVB) is/are added. Optionally, solvent(s) is/are added after addition of the binder(s). The resulting mixture is milled (second milling) for 12 to 48 hours, including all integer hour values and range therebetween. Optionally, a pore-forming material (e.g, PMMA or graphite) is added. If pore-forming material(s) is/are added at this point, the resulting mixture is milled (third milling) for 10 minutes to 6 hours, including all integer minute values and ranges therebetween). At least one pore-forming material is added. After all the starting materials are added and milled, the mixture of starting materials is degassed. For example, the mixture is degassed 1 hour after the starting materials are added and milled. Additional mixing (e.g., by agitation) can be carried out after addition (e.g., to provide a homogenous solution or uniform suspension) of any of the starting materials. For example, steps described in this example are carried out in the stated order and/or without any additional steps.

A slurry can be filtered (e.g., before casting such as, for example, tape casting) to remove agglomerates that may interfere with casting. For example, the slurry is filtered with a mesh with 180 μm spacing.

A variety of pore-forming materials (e.g., porogens) can be used. A pore-forming material can be any material that will vaporize or burn below 1000° C. Examples of pore-forming materials include, but are not limited to, carbon-containing materials (e.g., graphite (or graphitic materials), carbon fibers, carbon black, and the like), natural fibers (e.g., cellulose), starches, and polymer materials (e.g., PMMA, polyethylene, polystyrene, and the like). By selection of a pore-forming material (based on, for example, size and/or decomposition properties) a desired porosity (e.g., pore size and/or pore shape) can be obtained.

The mixing can carried out by known solid-state mixing techniques. The mixture of starting materials (e.g., dispersant, solvent(s), sintering facilitating material, ceramic material, plasticizer(s), binder(s), or combination thereof) can be ball milled.

The mixture may be milled with media such as stabilized-zirconia or alumina or another media known to one of ordinary skill in the art to achieve the prerequisite particle size distribution. To achieve the prerequisite particle size distribution, the calcined mixture may be milled using a technique such as vibratory milling, attrition milling, jet milling, ball milling, or another technique known to one of ordinary skill in the art, using media such as stabilized-zirconia, alumina, or another media known to one of ordinary skill in the art.

A method of fabricating ceramic-ionic conducing structures comprises forming a layer of a slurry. The layer can be formed by a tape casting method.

A method of fabricating ceramic-ionic conducing structures comprises forming a layer of a slurry. The layer can be formed on a tape using a tape casting methods.

A method of fabricating ceramic-ionic conducing structures comprises sintering a layer of a slurry. The sintering can be carried out in discrete steps (e.g., presintering (burn out) and sintering steps) or in single continuous step. The sintering can be carried out using equipment known in the art. It is desirable that the sintering be carried out and result in layers of ceramic-ionic conducing material that are flat (do not exhibit curling) and maintain all (or substantially all) of volatile compounds in the ceramic-ionic conducing material.

For example, sintering is carried out at 800° C. to 1200° C., including all integer ° C. values and ranges therebetween. In an example, sintering is carried out at 950° C. to 1050° C. or at 1000° C. The sintering can be carried out for 1 minute to 24 hours, including all integer minute values and ranges therebetween. One having skill in the art will appreciate that smaller particles may be sintered at lower temperatures and/or shorter sintering times and larger particles may be sintered at higher temperatures and/or longer sintering times.

During sintering (both heating and cooling), various heating or cooling rates can be used. For example, heating rates of 1 to 5° C./min, including all integer C/min values, can be used to heat the layer of slurry to the desired sintering temperature. For example, cooling rates of 1 to 15° C./min, including all integer C/min values and ranges therebetween, can be used to cool the sample after the desired sintering (time and temperature). For example, cooling rates of 1 to 10° C./min or 5° C./min can be used. Without intending to be bound by any particular theory, it is considered that use of heating or cooling rates that are too high can result in warping of the layer (e.g., layer on a tape).

Sintering (including, for example, presintering and sintering steps) is carried out in a low humidity (less than 1% or less than or equal to 1% absolute humidity) or no observable humidity environment. Humidity can be determined by methods known in the art. Without intending to be bound by any particular theory, it is considered that sintering under low humidity (less than 1% or less than or equal to 1% absolute humidity) or no observable humidity environment will provide an ion-conducing ceramic material having a desired phase (e.g., garnet phase) and/or structure.

Presintering is carried out in an atmosphere comprising oxygen. Sintering is carried out under a flow of a gas or mixture of gasses. The flow of gas can be an inert gas flow (e.g., argon gas). It is desirable that an inert gas flow be sufficient to remove CO₂ and/or H₂O (which can be formed during the sintering process) such than no observable carbonate materials are formed. The gas flow can comprise oxygen.

A method of fabricating ceramic ionic-conducing structures can comprise forming slurry, a layer of a slurry, and/or sintering a layer of slurry. These steps (or a combination thereof) can be carried out in a tape casting method.

The steps of the method described herein are sufficient to carry out the methods of making the ceramic ion-conducing ceramic structures of the present invention. Thus, in an example, the method consists essentially of a combination of the steps of the methods disclosed herein. In another example, the method consists of such steps. In various examples, the method comprises, consists essentially of, or consists of a combination of the steps of the methods disclosed herein in the order disclosed. Any particular chemical composition or combination of compounds can comprise or consist or consist essentially of the recite composition or compounds.

In an aspect, the present disclosure provides uses of ceramic ion-conducing structures. For example, the ceramic ion conducing structures can be used as solid-state electrolyte materials in ion-conducing batteries (e.g., solid-state ion-conducing batteries).

An ion-conducting battery can comprise ion-conducting solid state electrolyte comprising one or more ceramic ion conducing material of the present disclosure. For example, the batteries are lithium-ion, solid-state electrolyte batteries, sodium-ion, solid-state electrolyte batteries, or magnesium-ion solid-state electrolyte batteries. Lithium-ion (Li⁻) batteries are used, for example, in portable electronics and electric cars, sodium-ion (Na⁺) batteries are used, for example, for electric grid storage to enable intermittent renewable energy deployment such as solar and wind, and magnesium-ion (Mg²⁺) batteries are expected to have higher performance than Li⁺ and Na⁺ because Mg²⁺ carries twice the charge for each ion.

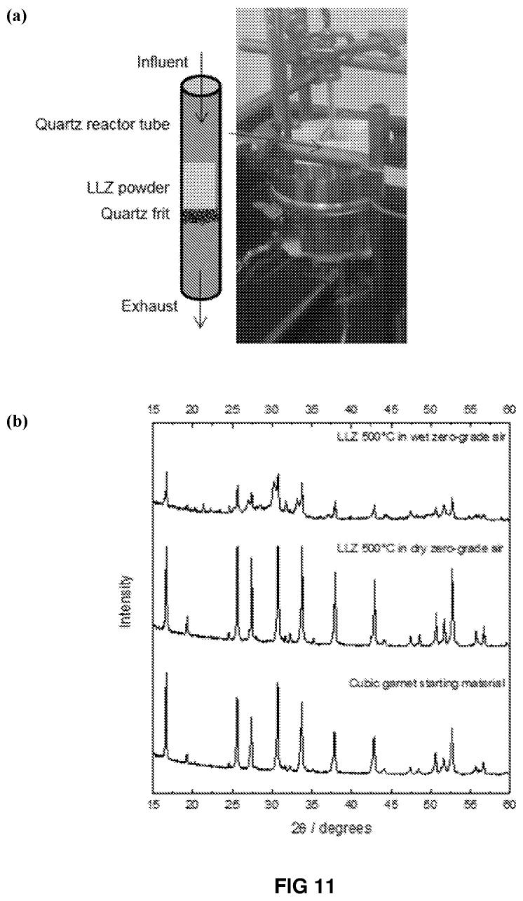

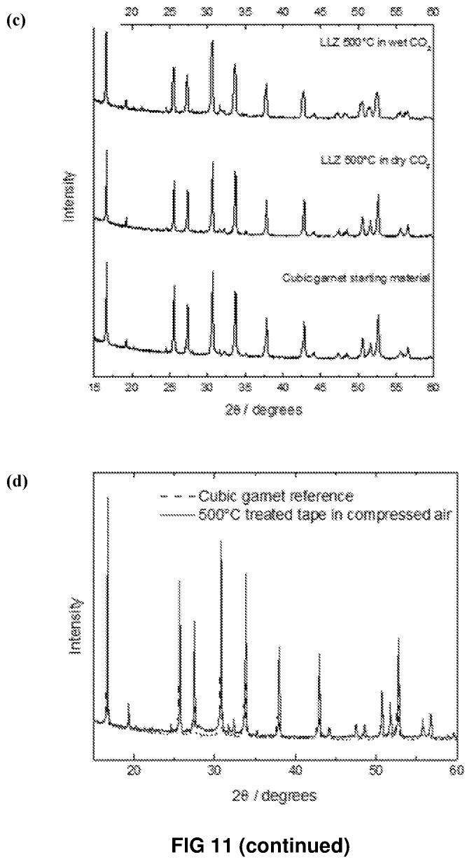

Solid-state batteries have advantages over previous batteries. For example, the solid electrolyte is non-flammable providing enhanced safety, and also provides greater stability to allow high voltage electrodes for greater energy density. The battery design (FIG. 11) provides additional advantages in that it allows for a thin electrolyte layer and a larger electrolyte/electrode interfacial area, both resulting in lower resistance and thus greater power and energy density. In addition, the structure eliminates mechanical stress from ion intercalation during charging and discharging cycles and the formation of solid electrolyte interphase (SEI) layers, thus removing the capacity fade degradation mechanisms that limit lifetime of current battery technology.

Solid state batteries comprise a cathode material, an anode material, and solid state electrolyte comprising one or more the ceramic ion-conducing materials. The ceramic ion conducing materials can have a dense region (e.g. a layer) and one or two porous regions (layers). The porous region(s) can be disposed on one side of the dense region or disposed on opposite sides of the dense region. The dense region and porous region(s) are fabricated from the same ceramic ion-conducing materials. The batteries conduct ions such as, for example, lithium ions, sodium ions, or magnesium ions.

The solid state battery can comprise a lithium-containing cathode material and/or a lithium-containing anode material, and a lithium-containing, ion-conducting, solid-state electrolyte material (e.g., a lithium containing ceramic ion-conducting structure). The solid state battery can comprise a sodium-containing cathode material and/or a sodium-containing anode material, and a sodium-containing, ion-conducting, solid-state electrolyte material (e.g., a sodium containing ceramic ion-conducting structure). The solid state battery can comprise a magnesium-containing cathode material and/or a magnesium-containing anode material, and a magnesium-containing, ion-conducting, solid-state electrolyte material (e.g., a magnesium containing ceramic ion-conducting structure).

The solid-state, ion-conducting electrolyte material is configured such that ions (e.g., lithium ions, sodium ions, or magnesium ions) diffuse into and out of the porous region(s) (e.g., porous layer(s)) of the solid-state, ion-conducting electrolyte material (e.g., ceramic ion-conducting structure) during charging and/or discharging of the battery. A solid-state, ion-conducting battery can comprise a solid-state, ion-conducting electrolyte material (e.g., a ceramic ion-conducting structure) comprising one or two porous regions (e.g., porous layer(s)) configured such that ions (e.g., lithium ions, sodium ions, or magnesium ions) diffuse into and out of the porous region(s) of solid-state, ion-conducting electrolyte material during charging and/or discharging of the battery.

The cathode comprises cathode material in electrical contact with the porous region of the ion-conducting, solid-state electrolyte material (e.g., ceramic ion-conducing structure). For example, the cathode material is an ion-conducting material that stores ions by mechanisms such as intercalation or reacts with the ion to form a secondary phase (e.g., an air or sulfide electrode). Examples of suitable cathode materials are known in the art.

The cathode material, if present, is disposed on at least a portion of a surface (e.g., a pore surface of one of the pores) of a porous region of the ion-conducting, solid-state electrolyte material (e.g., ceramic ion-conducing structure). The cathode material, when present, at least partially fills one or more pores (e.g., a majority of the pores) of a porous region or one of the porous regions of the ion-conducting, solid-state electrolyte material (e.g., ceramic ion-conducing structure). The cathode material can be infiltrated into at least a portion of the pores of the porous region of the ion-conducting, solid-state electrolyte material.

The cathode material can be disposed on at least a portion of the pore surface of the cathode side of the porous region of the ion-conducting, solid-state electrolyte material (e.g., ceramic ion-conducing structure), where the cathode side of the porous region of ion-conducting, solid-state electrolyte material is opposed to an anode side of the porous region of ion-conducting, solid-state electrolyte material (e.g., ceramic ion-conducing structure) on which the anode material is disposed.

The cathode material can be a lithium ion-conducting material. For example, the lithium ion-conducting cathode material is, lithium nickel manganese cobalt oxides (NMC, LiNiₓMn_{y}CO_{z}O₂, where x+y+z=1), such as LiCoO₂, LiNi_{1/3}Co_{1/3}Mn_{1/3}O₂, LiNi_{0.5}Co_{0.2}Mn_{0.3}O₂, lithium manganese oxides (LMOs), such as LiMn₂O₄, LiNi_{0.5}Mn_{1.5}O₄, lithium iron phosphates (LFPs) such as LiFePO₄, LiMnPO₄, and LiCoPO₄, and Li₂MMn₃O₈, where M is selected from Fe, Co, and combinations thereof. The ion-conducting cathode material can be a high energy ion-conducting cathode material such as Li₂MMn₃O₈, wherein M is selected from Fe, Co, and combinations thereof.

The cathode material can be a sodium ion-conducting material. For example, the sodium ion-conducting cathode material is Na₂V₂O₅, P2-Na_{2/3}Fe_{1/2}Mn_{1/2}O₂, Na₃V₂(PO₄)₃, NaMn_{1/3}Co_{1/3}Ni_{1/3}PO₄ and composite materials (e.g., composites with carbon black) thereof such as Na_{2/3}Fe_{1/2}Mn_{1/2}O₂@graphene composite.

The cathode material can be a magnesium ion-conducting material. For example, the magnesium ion-conducting cathode material is doped manganese oxide (e.g., MgₓMnO_{2.y}H₂O).

The cathode material can be an organic sulfide or polysulfide. Examples of organic sulfides include carbynepolysulfide and copolymerized sulfur.

The cathode material can be an air electrode. Examples of materials suitable for air electrodes include those used in solid-state lithium ion batteries with air cathodes such as large surface area carbon particles (e.g., Super P which is a conductive carbon black) and catalyst particles (e.g., alpha-MnO₂ nanorods) bound in a mesh (e.g., a polymer binder such as PVDF binder).

It may be desirable to use an electronically conductive material as part of the ion-conducting cathode material. For example, the ion-conducting cathode material also comprises an electrically conducting carbon material (e.g., graphene or carbon black), and the ion-conducting cathode material, optionally, further comprises an organic or gel ion-conducting electrolyte. The electronically conductive material may separate from the ion-conducting cathode material. For example, electronically conductive material (e.g., graphene) is disposed on at least a portion of a surface (e.g., a pore surface) of the porous region of the ceramic ion-conducting, SSE electrolyte structure and the ion-conducting cathode material is disposed on at least a portion of the electrically conductive material (e.g., graphene).

The anode comprises anode material in electrical contact with the porous region of the ion-conducting, solid-state electrolyte material (e.g., ceramic ion-conducing structure). For example, the anode material is the metallic form of the ion conducted in the solid state electrolyte (e.g., metallic lithium for a lithium-ion battery) or a compound that intercalates the conducting ion (e.g., lithium carbide, Li₆C, for a lithium-ion battery). Examples of suitable anode materials are known in the art.

The anode material, if present, is disposed on at least a portion of a surface (e.g., a pore surface of one of the pores) of the porous region of the ion-conducting, solid-state electrolyte material (e.g., ceramic ion-conducing structure). The anode material, when present, at least partially fills one or more pores (e.g., a majority of the pores) of the porous region of ion-conducting, solid-state electrolyte material. The anode material can be infiltrated into at least a portion of the pores of the porous region of the ion-conducting, solid-state electrolyte material.

The anode material can be disposed on at least a portion of the pore surface of an anode-side porous region of the ion-conducting, solid-state electrolyte material (e.g., ceramic ion-conducing structure), where the anode side of the ion-conducting, solid-state electrolyte material is opposed to a cathode side of the porous, ion-conducting, solid-state electrolyte (e.g., ceramic ion-conducing structure) on which the cathode material is disposed.

The anode material can be a lithium-containing material. For example, the anode material is lithium metal, or an ion-conducting lithium-containing anode material such as lithium titanates (LTOs) such as Li₄Ti₅O₁₂.

The anode material can be a sodium-containing material. For example, the anode material is sodium metal, or an ion-conducting sodium-containing anode material such as Na₂C₈H₄O₄ and Na_{0.66}Li_{0.22}Ti_{0.78}O₂.

The anode material can be a magnesium-containing material. For example, the anode material is magnesium metal.

The anode material can be a conducting material such as graphite, hard carbon, porous hollow carbon spheres and tubes, and tin and its alloys, tin/carbon, tin/cobalt alloy, or silicon/carbon.

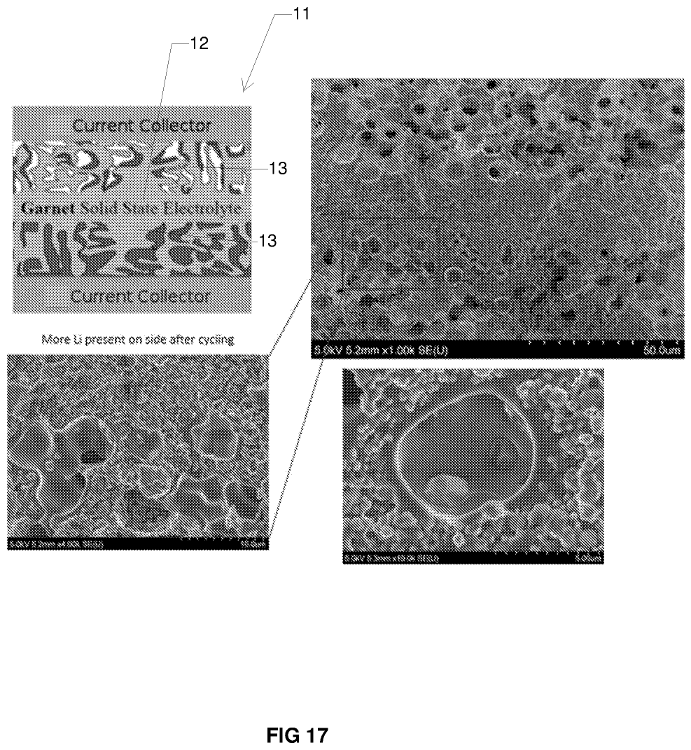

The ion-conducting solid state batteries 11 (e.g., lithium-ion solid state electrolyte batteries, sodium-ion solid state electrolyte batteries, or magnesium-ion solid state electrolyte batteries), such as shown in FIG. 17 (top left) can comprise current collector(s) 14, such as Ti current collector(s.) The batteries can have a cathode-side (first) current collector 14 disposed on the cathode-side of the porous, solid-state electrolyte material (porous layer 13) and an anode-side (second) current collector 14 disposed on the anode-side of the porous, solid-state electrolyte material (porous layer 13.) The current collectors 14 can be each independently fabricated of a metal (e.g., aluminum, copper, or titanium) or metal alloy (aluminum alloy, copper alloy, or titanium alloy).

The ion-conducting solid-state batteries (e.g., lithium-ion solid state electrolyte batteries, sodium-ion solid state electrolyte batteries, or magnesium-ion solid state electrolyte batteries) may comprise various additional structural components (such as bipolar plates, external packaging, and electrical contacts/leads to connect wires. The battery can further comprise bipolar plates. The battery can further comprise bipolar plates and external packaging, and electrical contacts/leads to connect wires. Repeat battery cell units can be separated by a bipolar plate.

The cathode material (if present), the anode material (if present), the SSE material, the cathode-side (first) current collector (if present), and the anode-side (second) current collector (if present) may form a cell. In this case, the solid-state, ion-conducting battery comprises a plurality of cells separated by one or more bipolar plates. The number of cells in the battery is determined by the performance requirements (e.g., voltage output) of the battery and is limited only by fabrication constraints. For example, the solid-state, ion-conducting battery comprises 1 to 500 cells, including all integer number of cells and ranges therebetween.

For example, an ion-conducting, solid-state battery or battery cell has one planar cathode and/or anode-electrolyte interface or no planar cathode and/or anode-electrolyte interfaces. For example, the battery or battery cell does not exhibit solid electrolyte interphase (SEI).

The following Statements provides examples of ceramic ion-conducting structures, methods of making a ceramic ion-conducting structures, and solid-state, ion-conducting batteries of the present disclosure.

Statement 1. A ceramic ion-conducting structure comprising a dense region (e.g., at least one dense layer) having a porosity of less than 5% and/or at least one porous region (e.g., porous layer) having a porosity of 40% to 90%.

Statement 2. A ceramic ion-conducting structure according to Statement 1, where the porous region has a random or ordered porous structure.

Statement 3. A ceramic ion-conducting structure according to any one of the preceding Statements, where the structure does not have observable dendrites (e.g., lithium dendrites in the case of structure having a lithium electrode material disposed on at least a portion of a surface of the structure).

Statement 4. A ceramic ion-conducting structure according to any one of the preceding Statements, where the structure is formed by a tape cast layer.

Statement 5. A method of making a ceramic ion-conducting structure comprising:

i) adding solvent(s) (e.g., isopropanol and toluene) to a dispersant (e.g., fish oil) and mixing until the dispersant is dissolved in the solvent(s),

ii) optionally, adding a sintering facilitating material (e.g., Al₂O₃) (e.g., at 0.1 to 0.2 mole per mole of ceramic material),

iii) adding a ceramic material,

iv) milling the resulting mixture from iii) for 1 to 47 hours,

v) adding plasticizer(s) (e.g., BBP) to the milled mixture from iv),

vi) adding binder(s) (e.g., PVP) to the mixture from v), Optionally, solvent(s) is/are added after addition of the binder(s),

vii) milling the mixture from vi) for 12 to 48 hours, or

i) adding solvent(s) (e.g., isopropanol and toluene) to a dispersant (e.g., fish oil) and mixing until the dispersant is dissolved in the solvent(s),

ii) optionally, adding a sintering facilitating material (e.g., Al₂O₃) (e.g., at 0.1 to 0.2 mole per mole of ceramic material),

iii) optionally, adding a first pore-forming material (e.g., PMMA or graphite),

iv) adding a ceramic material,

v) milling the resulting mixture from iv) for 1 to 47 hours,

vi) adding plasticizer(s) (e.g., BBP) to the milled mixture from v),

vii) adding binder(s) (e.g., PVP) to the mixture from vi), Optionally, solvent(s) is/are added after addition of the binder(s),

viii) optionally, adding solvent(s) (e.g., isopropanol and toluene) to the mixture from vii),

ix) milling the mixture from vii) for 12 to 48 hours,

x) optionally, adding a second pore-forming material (e.g., PMMA or graphite),

xi) if a second pore-forming material is added, milling the mixture from ix), for 10 minutes to 6 hours, and

xii) degassing the mixture from viii) or milled mixture from x).

Statement 6. A method of making a ceramic ion-conducting ceramic structure according to Statement 5, further comprising: forming a layer of slurry on a substrate (e.g., a tape).

Statement 7. A method of making a ceramic ion-conducting ceramic structure according to any one of Statements 5 or 6 further comprising, sintering a layer of slurry of claim 5 or the layer of slurry on a substrate of claim 6 at a temperature of 800° C. to 1200° C. for 1 minute to 24 hours.

Statement 8. A method of making a ceramic ion-conducting structure according to Statement 7, where the sintering is carried out in a low humidity (less than 1% or less than or equal to 1% absolute humidity) or no observable humidity environment.

Statement 9. A method of making a ceramic ion-conducting structure according to Statement 8, where the sintering is carried out under a flow of inert gas (e.g., argon gas).

Statement 10. A solid-state, ion-conducting battery comprising:
a) cathode material or anode material;
b) a ceramic ion-conducing structure of any of claims 1-4 or made by any of claims 5-9 (e.g., a solid-state electrolyte (SSE) material) (e.g., a layer or layers of the ion-conducing ceramic material) comprising a porous region having a plurality of pores, and a dense region,
c) wherein the cathode material or the anode material is disposed on at least a portion of the porous region and the dense region is free of the cathode material and the anode material, and
d) a current collector disposed on at least a portion of the cathode material or the anode material.

Statement 11. A solid-state, ion-conducting battery according to Statement 10, wherein the ion-conducing ceramic structure comprises two of the porous regions, the cathode material, the anode material, and the cathode material is disposed on at least a portion of one of the porous regions forming a cathode-side porous region and the anode material is disposed on at least a portion of the other porous region forming an anode-side porous region, and the cathode-side region and the anode-side region are disposed on opposite sides of the dense region, and further comprises a cathode-side current collector and an anode-side current collector.

Statement 12. A solid-state, ion-conducting battery according to any one of Statements 10 or 11, where the current collector is a conducting metal or metal alloy.

Statement 13. A solid-state, ion-conducting battery according to any of Statements 10 to 12, where the dense region of the ion-conducing ceramic material has a dimension of 1 μm to 100 μm and/or the porous region of the ion-conducing ceramic material that has the cathode material disposed thereon has a dimension of 20 μm to 200 μm and/or the porous region of the SSE material that has the anode material disposed thereon has a dimension of 20 μm to 200 μm.

Statement 14. A solid-state, ion-conducting battery according to any one of Statements 10 to 13, where the cathode material, the anode material, the SSE material, and the current collector form a cell, and the solid-state, ion-conducting battery comprises a plurality of the cells, each adjacent pair of the cells is separated by a bipolar plate.

The following examples are presented to illustrate the present disclosure. They are not intended to limiting in any manner.

### Example 1

The following is an example describing structures (e.g., multilayer structures) comprising ionically conductive ceramics, which enables the production of various high performance solid state battery chemistries. These structures can have porous outer layers, which can contain electrochemically active electrode materials, that are separated by a dense center layer. This configuration can be used, for example, for high performance electrochemical energy storage systems, creating space for high loading of active materials, electronic separation between active materials, and ionic conduction throughout.

A multilayer ceramic can be a triple layer structure, bilayer structure, or ordered structure. For example, FIG. 9a shows a triple layer ceramic lithium conductor Li_{6.75}La_{2.75}Ca_{0.25}Zr_{1.5}Nb_{0.5}O₁₂ (LLCZN) with ˜5 μm spherical pores in porous layers 13 on either side of a dense layer 12. FIG. 9 b is another example of a LLCZN triple layer with ˜10 μm spherical pores. It is desirable that the pores have high interconnectivity to allow electrode filling. This is demonstrated in FIG. 9c, showing a close-up of highly interconnected pores and the densified center layer (dense layer 12.) Pores should be highly interconnected but also maintain low tortuosity for fast kinetics. Ordered porosity, as shown on the bottom layer of FIG. 9d, can consistently reach tortuosities as low as 1. This ordered porosity was not created via the same techniques as FIGS. 9a-c but was 3D printed.

Various battery chemistries benefit from such a multilayered structure. This structure allows for the use of an alkaline metal anode, which represents the best energy density and lowest voltage anode in each chemistry. This invention is useful in such chemistries as:
Lithium ion with high voltage spinel cathode
Lithium ion with layered oxide cathode
Lithium ion with olivine phosphate cathode
Lithium-sulfur
Lithium-air
Use as a separator in a traditional liquid electrolyte lithium ion cell
Similar chemistries utilizing sodium, magnesium, potassium, or silver conductors instead of lithium conductors would also benefit from such a structure.

The fabrication of this product relies on a set of processing strategies that allow the creation of a well sintered ceramic body with the desired structure, phase and electrical properties. This example focuses specifically on the fabrication of the ionically conductive ceramic structure. To produce a high performance cell, it is desirable that the structure meets the requirements listed in Table 2, regardless of specific chemistry. The processes described herein used to create the structures shown in FIG. 9a-c achieves these goals.

TABLE 2
Properties by layer for a high performance solid state battery.

| Laver | Requirement | Purpose |
|---|---|---|
| Cathode-side | High ionic | Enabling low resistance/ |
| | conductivity | high current cycling |
| Cathode-side | High porosity | Allow high capacity filling |
| | | of electrode |
| Cathode-side | High strength | Overall device strength; |
| | | Prevention of fracture |
| | | during cycling |
| Center Separator | High ionic | Enabling low resistance/ |
| (Electrolyte-layer) | conductivity | high current cycling |
| Center Separator | Very low electronic | Blockage of short circuit |
| (Electrolyte-layer) | conductivity | current, allowing cell to |
| | | hold charge and have long |
| | | calendar life |
| Center Separator | Thin | Enabling low resistance/ |
| (Electrolyte-layer) | | high current cycling |
| Center Separator | High strength | Prevention of dendrite growth; |
| (Electrolyte-layer) | | Overall device strength |
| Center Separator | Highly densified | Prevention of dendrites; |
| (Electrolyte-layer) | | Prevention of electrode |
| | | materials coming into |
| | | physical contact |
| Anode-side | High strength | Overall device strength; |
| | | Prevention fo fracture |
| | | during cycling |
| Anode-side | High ionic | Enabling low resistance/ |
| | conductivity | high current cycling |
| Anode-side | High porosity | Allow high capacity filling |
| | | of electrode |

Beyond these requirements, control over exact microstructure is important. The porosity of the anode and cathode (or more generally, “electrode”) layers must be well interconnected to create a low tortuosity. Optimal pore size is chemistry dependent. Because sulfur fills pores easily and is not conductive to lithium ions, Li—S chemistries benefit from small pores (on the order of 1-10 μm diameter). On the other hand, lithium ion chemistries with an oxide cathode are hard to fill with micron-plus sized commercially available cathode such as LiCoO₂. These lithium ion chemistries benefit from larger pores (10-30 μm diameter). Ordered porosity with controlled aspect ratios allow the highest possible surface area with low tortuosity. Thickness of electrodes must be determined by design to allow high capacity and high rate capability.

This disclosure should not be limited by the materials synthesis method, dimensions of the structure, the size or dimension of the pores, the exact recipe of the tapes, or the source of the porogens. Discoveries that led to the successful fabrication of the structure include, for example, the atmospheric protection and the importance of particle size reduction.

Fabrication Procedure and Development. This section discusses the overall procedure including materials synthesis, milling, tapecasting, pre-sintering, sintering, and the nuanced procedures required to achieve the desired structure. The research that led to the development of these procedures will also be discussed.

The ionically conductive material can have, among other materials, various members of the lithium garnet family. There are many members of the garnet family which would satisfy the requirements of a viable device (e.g., low electronic conductivity). This work has been demonstrated with Li_{6.75}La_{2.75}Ca_{0.25}Zr_{1.5}Nb_{0.5}O₁₂ (LLCZN, nominal composition), a variant of the Li₇La₃Zr₂O₁₂ (LLZ) composition. The lithium garnet material is produced via solid state reaction by mixing CaCO₃, La₂O₃, ZrO₂, and Nb₂O₅ in stoichiometric quantities. LiOH, LiNO₃ or Li₂CO₃ is added with 10% excess to account for volatility during sintering. The raw materials are mixed with isopropanol and 5 mm diameter yttria-stabilized zirconia (YSZ) balls to form a slurry for milling. After 24 hours of milling, the mixture is screened through a 38 μm mesh and separated from the milling media. The slurry is then dried for several hours in a 100° C. oven, lightly ground in a mortar and pestle to re-powderize. The powder is placed in a covered Al₂O₃ crucible and calcined at 900° C. for 10 hours. After calcining, the ceramic powder is milled in isopropanol for 3 days with 5 mm YSZ balls, then 18 days with 2 mm YSZ balls.

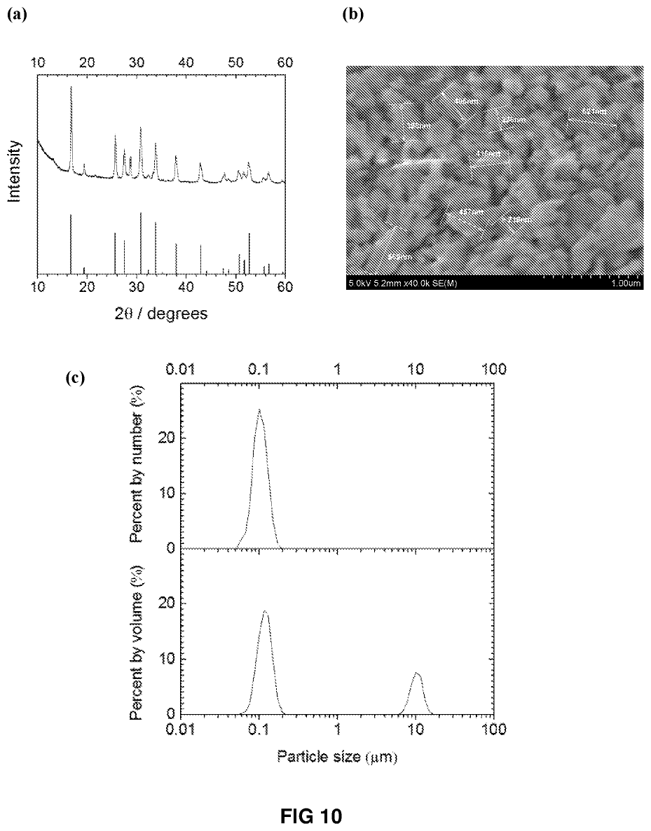

This synthesis procedure produces highly conductive, cubic phase lithium garnet as can be seen in the X-ray diffraction pattern in FIG. 10a. FIGS. 10b and 10c show results from scanning electron microscopy and dynamic light scattering demonstrating that nearly all the particles are under 500 nm in size. Brunauer-Enunett-Teller particle size analysis confirm submicron particles with 20-25 m²/g surface area. This small particle size and high surface area are important for reducing sintering temperature and time, which in tum retain lithium and enable final fabrication of the triple layer structure meeting all the requirements as listed in Table 2.

From this LLCZN powder, complex microstructured ceramics can be scalably produced via tapecasting, followed by organic burnout, then high temperature sintering. While this is a widely employed technique in industry, every material requires unique formulations and compositions of tapecasting slurry to produce tapes that have the right properties and successfully produce the desired sintered structure. The slurries must cast nicely to produce tapes of consistent thickness and without defects. Tapes must be flexible and maintain this flexibility for a long shelf life. Tapes must be able to be laminated to one another well enough that delamination does not occur during sintering.

The slurry recipes in Tables 2 and 3 represent significant development work to produce tapes that meet these requirements. However, these are not the only functional recipes that were achieved and can be tailored to the desired structure, with increased or decreased porosity and changes of tape thickness among other possible variations. Furthermore, a significant component of successful tapecasting is the procedure used to create the slurry. These compositions could result in inferior tapes if the addition order and notes in Tables 2 and 3 are not followed.

Polymer-ceramic composite tapes are cast for the separator layer and the electrode layers separately. Slurries for tape casting are prepared by mixing the garnet and Al₂O₃ nanopowder in isopropanol, toluene and a small amount of fish oil for 24 hours. After the addition of polyvinyl butyral (PVB) and benzyl butyl phthalate (BBP), the solution is milled for another 24 hours. Slurries used to create the electrode layers of the triple layer contain 10 or 15 μm diameter crosslinked polymethyl methacrylate (PMMA) spheres and/or 7-11 μm graphite particles to create porosity. An example slurry recipe for the electrolyte layer tape is given in Table 3, sorted by order of addition to the slurry and normalized to grams of garnet. Similarly, Table 4 shows a slurry recipe for a porous layer tape. These are not the only possible recipes to achieve viable tapes, but are two examples of what has been used in our procedure. In addition to many variations on these recipes, we have also created tapes using all-PMMA pore porogen, all-graphite porogen, and other porogens such as starch and cellulose.

Control of porosity is achieved via selection of porogen. Only interconnected pores with an electronic path to the current collector will be electrochemically active. Furthermore, only pores with sufficiently sized connections are able to be filled with electrode material. The image shown in FIG. 9a is of a triple layer produced with 10 μm diameter crosslinked PMMA spheres in the electrode layer tapes. These spheres decompose and volatilize during the burnout stage, leaving spherical voids which shrink during sintering. However, interconnectivity between pores is low. Because the LLCZN grains were not sintered together, the volatilizing PMMA easily escapes and does not push through channels between pores. In order to increase interconnectivity of pores, graphite can also be used as a porogen. Graphite does not finish burning out until above 800 C, which preserves the integrity of the pores and allows a continual off-gassing which forces the connections in the pores to stay open. The triple layer in FIG. 9c uses only graphite as porogen. Even a small amount of graphite can be enough to keep the maintain pore connectivity, as can be seen in FIG. 9b showing a triple layer made with a PMMA/graphite ratio of 19/1.

TABLE 3
Formulation for lithium garnet tape for dense center layer

| Addition | | Amount | |
|---|---|---|---|
| Day | Material | (g/g LLCZN) | Note |
| 1 | Fish oil | 0.05 | |
| 1 | Isopropanol | 0.95 | |
| 1 | Toluene | 0.95 | Bottle is shaken to |
| | | | completely dissolve |
| | | | fish oil after this |
| | | | addition. |
| 1 | Al₂O₃ | 0.006 | 0.1-0.2 mole Al₂O₃/ |
| | | | mole LLCZN. |
| 1 | LLCZN | 1 | |
| 2 | BBP | 0.28 | Bottle is shaken after |
| | | | this addition. |
| 2 | PVB | 0.24 | Bottle is shaken after |
| | | | this addition until |
| | | | PVB particles are |
| | | | dissolved |
| 2 | Cyclohexanone | 0.02 | |

TABLE 4
Formulation for lithium garnet tape for porous outer layers

| Addition | | Amount | |
|---|---|---|---|
| Day | Material | (g/g LLCZN) | Note |
| 1 | Fish oil | 0.04 | |
| 1 | Isopropanol | 1.25 | |
| 1 | Toluene | 1.15 | Bottle is shaken to |
| | | | completely dissolve |
| | | | fish oil after this |
| | | | addition. |
| 1 | Al₂O₃ | 0.006 | 0.1-0.2 mole Al₂O₃/ |
| | | | mole LLCZN. |
| 1 | Graphite | 0.04 | |
| 1 | LLCZM | 1 | |
| 2 | BBP | 0.55 | Bottle is shaken after |
| | | | this addition. |
| 2 | PVB | 0.0.65 | Bottle is shaken after |
| | | | this addition until |
| | | | PVB particles are |
| | | | dissolved |
| 3 | PMMA | 0.37 | PMMA added 1 hour |
| | | | before degassing. |

It may be important that for each addition day, the materials added are mixed for 24 hours for proper homogeneity. On the day of tapecasting, the slurries are degassed to prevent bubbles from disrupting the process of tape drying and ceramic powder packing. Degassing is accomplished by stirring the slurry while pulling low (˜500 mmHg) vacuum. The slurries for the electrolyte and electrode layers are degassed for 1 and 3 hours, respectively. After degassing, tapecasting is performed by pouring the slurry into a reservoir. A sheet of silicone coated mylar is pulled under the reservoir at 10 cm/minute. The film thickness is limited by a doctor blade set to the desired height. Common heights for electrolyte layer tapes and electrode layer tapes are 178 μm and 465 μm, respectively. Smaller or larger blade heights can be used to produce thinner or thicker tapes. The tape is pulled onto a 49° C. heated bed for drying. Tapes are allowed to dry for around 1 hour before removing from the heated bed.

After tapecasting, the tapes are laminated together to form a triple layer. A section of porous-layer tape and a section electrolyte layer tape are pressed at 3 tons at 71° C. for 30 minutes. After pressing, the now bilayer tape is pressed with another section of porous-layer tape for 30 minutes to create a porous-dense-porous triple layer. Alternatively, all three-layers can be laminated at the same time. Cells are punched or cut from this triple layer depending on the desired size.

To produce the final sintered ceramic, punches from this triple layer tape are heated in a furnace to burn out the organics and sinter the ceramic particles into a single body. The tape punch out must sit on a bed of the mother powder. The tape punch out is either covered by more of the mother powder or by a powder nonreactive with garnet such as MgO. A porous Al₂O₃ block is placed on top of this powder to provide a small amount of compression to keep the cells flat while still providing gas flow. Various furnace profiles for the burnout and sintering stages have been shown to work.

An essential breakthrough that led to this product fabrication procedure was the discovery of humidity related reactions in the furnace. It was found that LLZ and LLCZN tapes could not consistently be taken through the burnout stage, between room temperature and about 650° C., without losing the garnet phase. After ruling out reactions during tapecasting, we discovered that the indoor humidity was causing reactions with the garnet in the furnace. Previous research has shown that lithium garnet is not stable in water. However, there has been no report of the stability of the material in humid conditions at an elevated temperature, such as the environment in a furnace on a humid day. This is not usually a concern because at high temperatures, the relative humidity of the atmosphere is very low. The absolute humidity, though, can be high. An additional concern was that organics in the tape are converted to water and CO₂ during binder burnout stage, increasing the humidity and providing another possible reactant.

FIG. 11a shows the setup of the experiment used to determine the furnace stability of lithium garnet with water and CO₂. LLZ was heated in a quartz reactor in a 20 sccm flow of the test gas. The furnace was ramped to 500° C., held for 30 minutes, and cooled to room temperature. X-ray diffraction was used to measure phase purity of the starting material and the material after the test.

It can be seen in FIG. 11b that annealing in wet zero-grade air (79% N₂, 21% O₂ without CO₂ or any of the other constituent gases comprising atmospheric air) leads to complete decomposition of the garnet phase and the production of numerous side phases. When annealed in dry zero-grade air, the garnet phase remains intact.

It can be seen in FIG. 11c that annealing garnet in wet CO₂ produces nearly pure phase garnet. There is some peak splitting in the wet CO₂ not seen in the dry CO₂ which may suggest that the garnet is changing from cubic to tetragonal phase, but this is a major improvement over the same heating conditions in wet air. This indicates that CO₂ is not damaging to the garnet phase and may be protective.

FIG. 11d shows that this knowledge can be applied to a tapecast garnet ceramic through the burnout of the organics at 500° C. The burnout of the tape was performed using compressed air, which is low humidity but not completely dry, and produced nearly pure phase cubic garnet.

During the burnout (or “presintering”) phase, the PVB and BBP are oxidized and are carried away by the flowing furnace gas. It is important to provide sufficient oxygen for these reactions to happen. It is also important to burn slowly enough to not disturb the packing of the LLCZN ceramic particles. This is also the stage where the PMMA breaks down and volatilizes. The burnout profiles most commonly used are listed below:
Ramp from room temperature to 750° C. at 2° C./minute under 35 cm³/minute O₂ flow.
Ramp from room temperature to sintering temperature at 3° C./minute with 30 minute stops at 200° C., 450° C. and 650° C. under 35 cm³/minute O₂ flow.

After the burnout stage, the furnace does not need to be cooled to room temperature. The furnace can continue to heat to the full sintering temperature, usually at a rate of 3° C./minute. Due to the small particle size, high surface area, and sharp angles of the particles, all sintering temperatures used in this procedure are significantly lower than literature for the same materials. The two most commonly used sintering profiles in our process are a high temperature, short time profile and a lower temperature, longer time. Each of these temperatures can be reached with traditional, low cost nichrome heating elements:
950° C. hold for 5 hours, followed by cooling at 3-5° C./minute
1050° C. hold for 20 minutes, followed by cooling at 3-5° C./minute

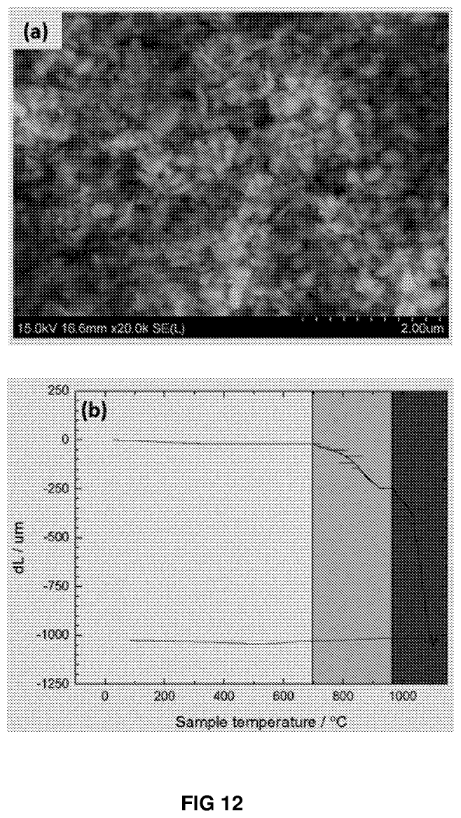

Lithium garnet is notoriously difficult to sinter into a dense body. Most examples of dense sintering in literature include the use of hot-pressing, a procedure not suited for device fabrication. Significant work went into developing a procedure that would allow densification of the garnet during sintering. The most important development in this pursuit is the milling procedure that produces the powder shown in FIG. 12a. It can be seen that not only are the particles sub-micron and high surface area, but they also have sharp edges and acute vertices. Together, this dramatically increases the surface energy of the powder, kinetically favoring sintering as a method to reduce surface energy. A dilatometric study, shown in FIG. 12b, indicates that a significant amount of sintering occurs before 1000° C., where lithium loss starts to be a significant factor. This is the rationale behind the longer 5 hour sintering time at 950° C. or short 20 minute hold at 1050° C., which both promote sintering.

The atmosphere in the furnace during the burnout and the sintering stage must be controlled. Oxygen or dry air is used during the burnout stage to allow for oxidation of organics. After the burnout stage, the gas for the sintering stage is run to completely flush the furnace. During the sintering hold, the gas flow is shut off and the sintering gas is held to slow lithium loss. The gas is flowed again during cooling. The sintering stage has been demonstrated in oxygen and argon, though we have demonstrated that the most important factors are avoidance of CO₂ and humidity. Because graphite does not fully burn out below about 850° C., tapes including graphite must use an oxidizing atmosphere in the sintering stage if all graphite is to be fully removed.

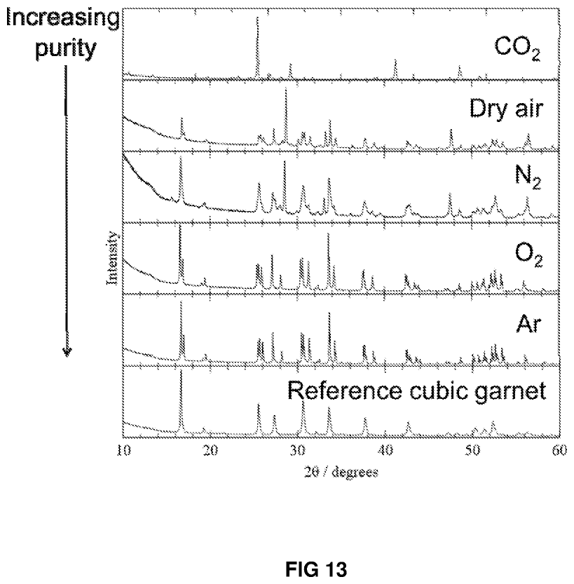

Many alkaline conducting ceramics contain volatile elements that can be lost at a high rate at these elevated temperatures, hindering sinterability, resulting in reduced phase purity and/or device performance. In order to reduce lithium loss, factors affecting the rate of lithium loss were investigated. After binder burnout, the garnet is heated to temperatures between 800-1200° C. for sintering, depending on composition, particle size, and desired sintering time. At high temperature, loss of lithium in the form of volatile side phases can cause loss of garnet phase. The use of controlled gas environments during sintering can prevent the formation of some lithium-containing side phases by removing the reactants commonly found in air such as N, and CO₂. FIG. 13 shows the diffraction patterns of LLCZN garnet tapes heated to 500° C. in dry air and held for 1 hour for binder burnout, then heated to 1050° C. in various test gases. The samples were held for 1 hour then cooled to room temperature for XRD. These results indicate that sintering in O₂ or Ar in these conditions leads to significant lithium retention over sintering in N₂, CO₂ or dry air.

The results of this study also indicate that CO₂ is especially damaging to the garnet and should be avoided. For this reason, binder burnout is performed in O₂ to cause more rapid combustion, reducing the amount of time the CO₂ combustion product is in close proximity to the garnet.

After sintering, the desired structure is complete and is stored in an argon-filled glovebox to protect the surface of the garnet from carbonate formation.

### Example 2

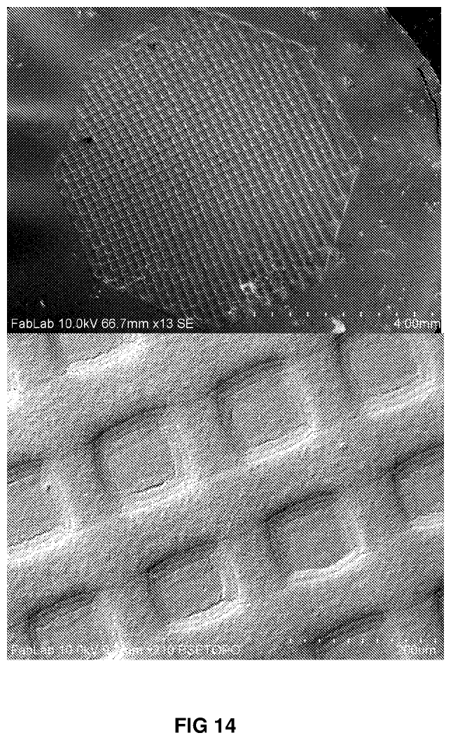

The following is an example of a ceramic ion-conducting structure with ordered structures. For increased surface area, grids can be printed. An SEM of a 10 layer print on top of a dense tape after sintering is shown in FIG. 14.

### Example 3

The following is an example of electrical data obtained using ceramic ion-conducting structures of the present disclosure.

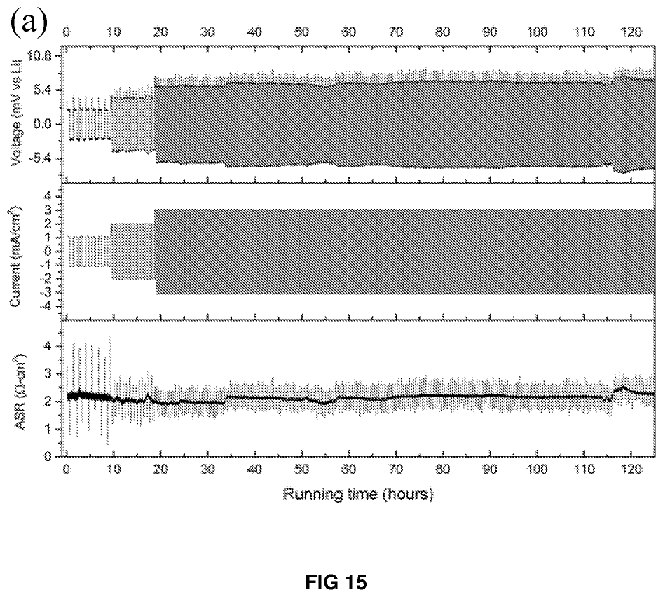

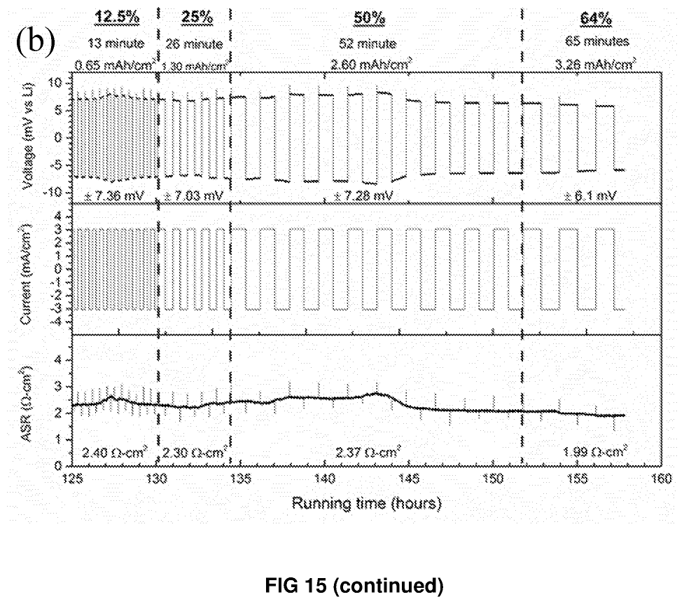

Cycling data. The pores of a triple layer garnet structure were filled with lithium metal which was cycled from one porous layer to the other and back at high rate. In FIG. 15(a), it can be seen that the current is increased incrementally from 1 mA/cm² to 3 mA/cm², with a corresponding response in the voltage. The area specific resistance (ASR) stays around 2-3 Ωcm², which is significantly below the 20-30 Ocm2 of commercially available 18650 lithium batteries. The FIG. 15(b), shows an increase in the amount of lithium removed from the pores, with a continuation of the 3 mA/cm² rate in the same cell. This cell was cycled hundreds of times without degradation, only to be stopped and disassembled for SEM analysis.

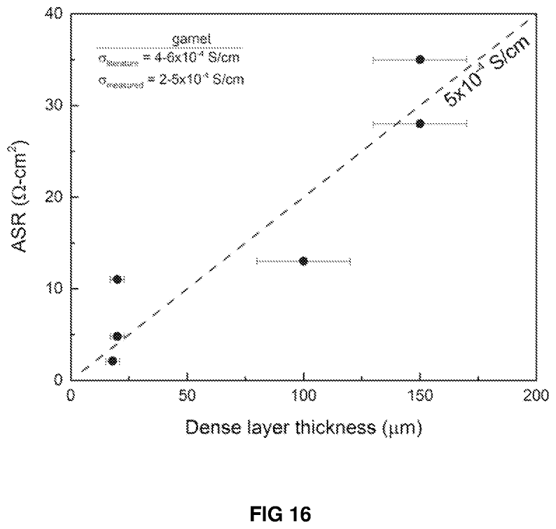

This is the expected resistance as calculated from the conductivity of the material and the thickness of the dense layer. This is shown in FIG. 16 with several tested samples labeled on the plot.

### Example 4

The following describes SEM analysis of an example of an electrical cell comprising a ceramic ion-conducting structure of the present disclosure.

A schematic of an embodiment of a battery 11 is shown in FIG. 9 (top left), with a dense layer 12, two porous layers 13 and two current collectors 14. SEM of lithium in garnet pores. An SEM analysis of the disassembled cycled cell was performed (see FIG. 17). The lithium metal can be seen as the smooth sections in the SEM images. The cell was stopped at the end of a deep cycle, causing most of the lithium metal to be plated on the bottom side.

### Examples

The following describes analysis of the flatness of ceramic ion-conducting structures of the present disclosure.

Flatness of fabricated structures. Flatness of the sintered structures is important to allow compact stacking and prevent breakage. To measure flatness, grid scans were taken using the Keyence LK-H082 Ultra High-Speed/High-Accuracy Laser Displacement Sensor attachment of a nScrypt 3D printer, which is capable of measuring sample topology with resolution better than 20 μm in the x and y directions and about 7 μm in the z direction.

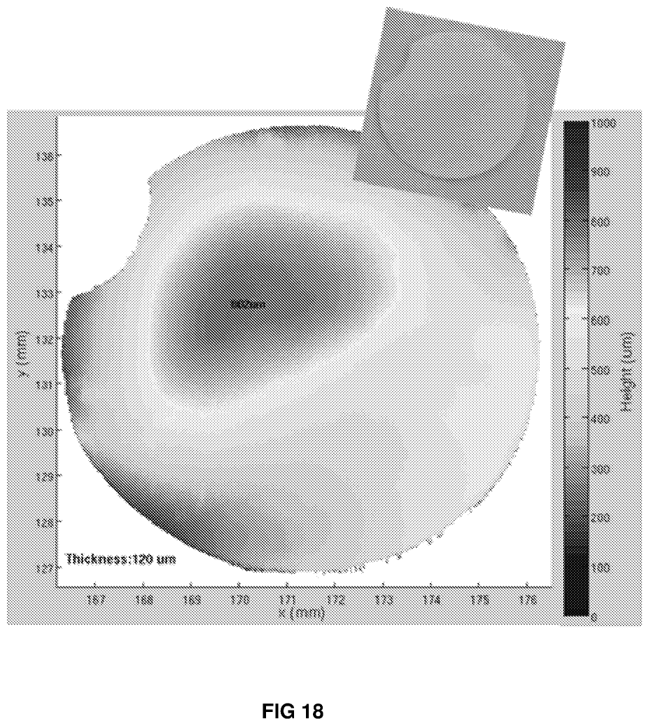

The first scan, shown as a colormap in FIG. 18, represents a grid scan of a cell sintered on a dense Al₂O₃ plate with a light powderbed on top and bottom, covered by a porous Al₂O₃ block. The inset shows a photograph of the same cell. The thickness of the cell is calculated by cutting out the background of the scan using an increasing cutoff until the shape of the trilayer is affected. The accuracy of this method has been confirmed with SEM to within about 10-15 urn. All data analysis for these measurements has been performed in MATLAB.

It can be seen in FIG. 12 that the cell is 120 μm with a peak height of 802 μm, giving a P−V Error of 682 μm, based on Equation 1, where peak height is the maximum height measured on the sample and valley height is the thickness of the cell.

P−V Error=Peak height −Valley height (Eqn. 1)

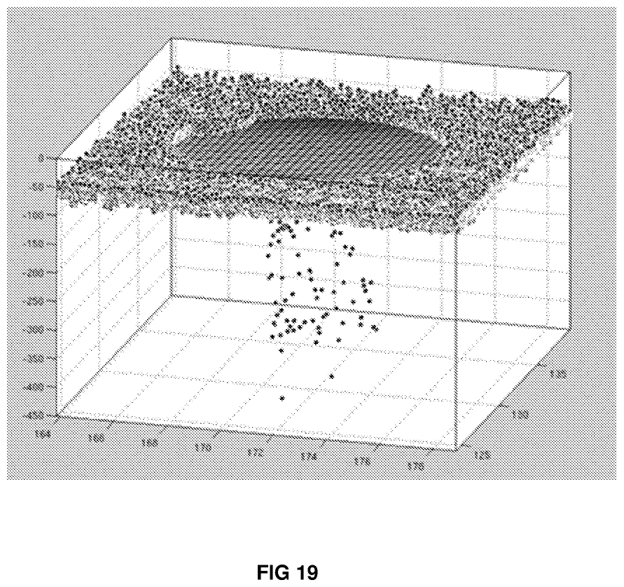

In order to obtain an accurate measure, the z height of the sample holder must be absolutely zeroed and leveled. In order to achieve this, we can subtract the trilayer data from the grid scan of the background and fit a curve to it. This curve is used to subtract the background from the trilayer data points. The fitting of the background data can be seen in FIG. 19. This operation is performed for every trilayer scanned. Also apparent are the outliers created via edge effects in the scanning. These points are removed with a high and low cutoff of data points, which is performed computationally for each cell after scanning.

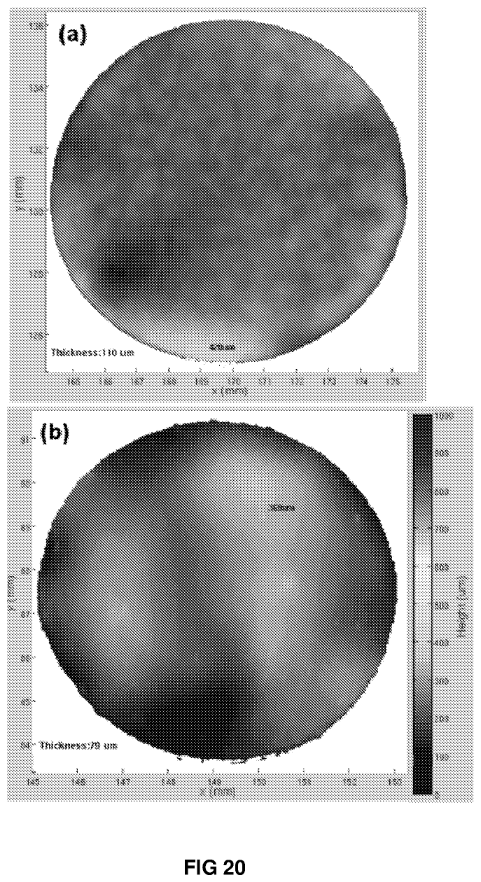

We fabricated flatter cells by applying more consistent pressure to the tops of the cells during sintering. For the first cell, shown on the left of FIG. 20, a powder was ground finely then distributed evenly to the top of the sample. For the second cell, a ceramic pellet was placed underneath and on top of the triple layer tape. Both of these cells sintered much more consistently than previous cells, showing peak to valley differences of 310 μm and 290 μm, respectively.

Although claimed subject matter will be described in terms of certain embodiments, other embodiments, including embodiments that do not provide all of the benefits and features set forth herein, are also within the scope of this disclosure. Various structural, logical, process step, and electronic changes may be made without departing from the scope of the disclosure.

Ranges of values are disclosed herein. The ranges set out a lower limit value and an upper limit value. Unless otherwise stated, the ranges include all values to the magnitude of the smallest value (either lower limit value or upper limit value) and ranges between the values of the stated range.

All ranges disclosed herein are inclusive of their upper and lower limits, and include each value there between to the hundredth decimal place, and all ranges within those limits.

Although the present disclosure has been described with respect to one or more particular embodiments and/or examples, it will be understood that other embodiments and/or examples of the present disclosure may be made without departing from the scope of the present disclosure.

As used herein, the words “approximately”, “about”, “substantially”, “near” and other similar words and phrasings are to be understood by a person of skill in the art as allowing for an amount of variation not substantially affecting the working of the device, example or embodiment. In those situations where further guidance is necessary, the degree of variation should be understood as being 10% or less.

Having now described the invention in accordance with the requirements of the patent statutes, those skilled in this art will understand how to make changes and modifications to the present invention to meet their specific requirements or conditions. Such changes and modifications may be made without departing from the scope and spirit of the invention as disclosed herein.

The foregoing Detailed Description of exemplary and preferred embodiments is presented for purposes of illustration and disclosure in accordance with the requirements of the law. It is not intended to be exhaustive nor to limit the invention to the precise form(s) described, but only to enable others skilled in the art to understand how the invention may be suited for a particular use or implementation. The possibility of modifications and variations will be apparent to practitioners skilled in the art. No limitation is intended by the description of exemplary embodiments which may have included tolerances, feature dimensions, specific operating conditions, engineering specifications, or the like, and which may vary between implementations or with changes to the state of the art, and no limitation should be implied therefrom. Applicant has made this disclosure with respect to the current state of the art, but also contemplates advancements and that adaptations in the future may take into consideration of those advancements, namely in accordance with the then current state of the art. It is intended that the scope of the invention be defined by the Claims as written and equivalents as applicable. Use of the word “or” should be understood to also include the meaning “and”, except where the context indicates otherwise. Reference to a claim element in the singular is not intended to mean “one and only one” unless explicitly so stated. Moreover, no element, component, nor method or process step in this disclosure is intended to be dedicated to the public regardless of whether the element, component, or step is explicitly recited in the Claims.

### Concepts

The present disclosure also includes at least the following concepts.

Concept 1-1) A solid-state, ion-conducting battery comprising:

a) cathode material or anode material;

b) a solid-state electrolyte (SSE) material comprising a porous region having a plurality of pores, and a dense region,

wherein the cathode material or the anode material is disposed on at least a portion of the porous region and the dense region is free of the cathode material and the anode material, and

c) a current collector disposed on at least a portion of the cathode material or the anode material.

Concept 1-2) The solid-state, ion-conducting battery of Concept 1-1, wherein the SSE material comprises two of the porous regions, the cathode material, the anode material, and the cathode material is disposed on at least a portion of one of the porous regions forming a cathode-side porous region and the anode material is disposed on at least a portion of the other porous region forming an anode-side porous region, and the cathode-side region and the anode-side region are disposed on opposite sides of the dense region, and further comprises a cathode-side current collector and an anode-side current collector.
Concept 1-3) The solid-state, ion-conducting battery of Concept 1-1, wherein the cathode material is a lithium-containing material, a sodium-containing cathode material, or a magnesium-containing cathode material.
Concept 1-4) The solid-state lithium ion battery of Concept 1-1, wherein the cathode material comprises a conducting carbon material, and the cathode material, optionally, further comprises an organic or gel ion-conducting electrolyte.
Concept 1-5) The solid-state, ion-conducting battery of Concept 1-3, wherein the lithium-containing electrode material is a lithium-containing, ion-conducting cathode material selected from LiCoO₂, LiFePO₄, Li₂MMn₃O₈, wherein M is selected from Fe, Co, and combinations thereof.
Concept 1-6) The solid-state, ion-conducting battery of Concept 1-3, wherein the sodium-containing cathode material is a sodium-containing, ion-conducting cathode material is selected from Na₂V₂O₅, P2-Na_{2/3}Fe_{1/2}Mn_{1/2}O₂, Na₃V₂(PO₄)₃, NaMn_{1/3}Co_{1/3}Ni_{1/3}PO₄, and Na_{2/3}Fe_{1/2}Mn_{1/2}O₂@graphene composite.

Concept 1-7) The solid-state, ion-conducting battery of Concept 1-3, wherein the magnesium-containing cathode material is a magnesium-containing, ion-conducting cathode material and is a doped manganese oxide.

Concept 1-8) The solid-state, ion-conducting battery of Concept 1-1, wherein the anode material is a lithium-containing anode material, a sodium-containing anode material, or a magnesium-containing anode material.

Concept 1-9) The solid-state, ion-conducting battery of Concept 1-8, wherein the lithium-containing anode material is lithium metal.

Concept 1-10) The solid-state, ion-conducting battery of Concept 1-8, wherein the sodium-containing anode material is sodium metal or an ion-conducting, sodium-containing anode material selected from Na₂C₈H₄O₄ and Na_{0.66}Li_{0.22}Ti_{0.78}O₂.

Concept 1-11) The solid-state, ion-conducting battery of Concept 1-8, wherein the magnesium-containing anode material is magnesium metal.

Concept 1-12) The solid-state, ion-conducting battery of Concept 1-1, wherein the SSE material is a lithium-containing SSE material, a sodium-containing SSE material, or a magnesium-containing SSE material.

Concept 1-13) The solid-state, ion-conducting battery of Concept 1-12, wherein the lithium-containing SSE material is a Li-garnet SSE material.

Concept 1-14) The solid-state lithium ion battery of Concept 1-12, wherein the Li-garnet SSE material is cation-doped Li₅La₃M¹₂O¹₂, where M¹ is Nb, Zr, Ta, or combinations thereof, cation doped Li₆La₂BaTa₂O₁₂, cation-doped Li₇La₃Zr₂O₁₂, and cation-doped Li₆BaY₂M¹₂O¹₂, where cation dopants are barium, yttrium, zinc, or combinations thereof.

Concept 1-15) The solid-state lithium ion battery of Concept 1-13, wherein said Li-garnet SSE material is Li₅La₃Nb₂O₁₂, Li₅La₃Ta₂O₁₂, Li₇La₃Zr₂O₁₂, Li₆La₂SrNb₂O₁₂, Li₆La₂BaNb₂O₁₂, Li₆La₂SrTa₂O₁₂, Li₆La₂BaTa₂O₁₂, Li₇Y₃Zr₂O₁₂, Li_{6.4}Y₃Zr₁₄Ta_{0.6}O₁₂, Li_{6.5}La_{2.5}Ba_{0.5}TaZrO₁₂, Li₆BaY₂M¹₂O₁₂, Li₇Y₃Zr₂O₁₂, Li_{6.75}BaLa₂Nb_{1.75}Zn_{0.25}O₁₂, or Li_{6.75}BaLa₂Ta_{1.75}Zn_{0.25}O₁₂.

Concept 1-16) The solid-state, ion-conducting battery of Concept 1-1, wherein the current collector is a conducting metal or metal alloy.
Concept 1-17) The solid-state, ion-conducting battery of Concept 1-1, wherein the dense region of the SSE material has a dimension of 1 μm to 100 μm and/or the porous region of the SSE material that has the cathode material disposed thereon has a dimension of 20 μm to 200 μm and/or the porous region of the SSE material that has the anode material disposed thereon has a dimension of 20 μm to 200 μm.
Concept 1-18) The solid-state, ion-conducting battery of Concept 1-1, wherein the ion-conducting cathode material, the ion-conducting anode material, the SSE material, and the current collector form a cell, and the solid-state, ion-conducting battery comprises a plurality of the cells, each adjacent pair of the cells is separated by a bipolar plate.
Concept 1-19) A solid-state, ion-conducting battery comprising a solid-state electrolyte (SSE) material comprising a porous region of electrolyte material disposed on a dense region of electrolyte material, the SSE material configured such that ions diffuse into and out of the porous region of the SSE material during charging and/or discharging of the battery.
Concept 1-20) The solid-state, ion-conducting battery of Concept 1-19, where the SSE material comprises two porous regions disposed on opposite sides of the dense region of the SSE material.
Concept 2-1) A ceramic ion-conducting structure comprising a dense region having a porosity of less than 5% and/or at least one porous region having a porosity of 40% to 90%.
Concept 2-2) The ceramic ion-conducting structure of Concept 2-1, wherein the porous region has a random or ordered porous structure.
Concept 2-3) The ceramic ion-conducting structure of Concept 2-1, wherein the structure does not have observable dendrites.
Concept 2-4) The ceramic ion-conducting structure Concept 2-1, wherein the structure is formed by a tape cast layer.
Concept 2-5) A method of making a ceramic ion-conducting structure comprising:
i) adding solvent(s) to a dispersant and mixing until the dispersant is dissolved in the solvent(s),
ii) optionally, adding a sintering facilitating material,
iii) adding a ceramic material,
iv) milling the resulting mixture from iii) for 1 to 47 hours,
v) adding plasticizer(s) to the milled mixture from iv),
vi) adding binder(s) to the mixture from v), optionally, solvent(s) is/are added after addition of the binder(s),
vii) milling the mixture from vi) for 12 to 48 hours, or
i) adding solvent(s) to a dispersant and mixing until the dispersant is dissolved in the solvent(s),
ii) optionally, adding a sintering facilitating material,
iii) optionally, adding a first pore-forming material,
iv) adding a ceramic material,
v) milling the resulting mixture from iv) for 1 to 47 hours,
vi) adding plasticizer(s) to the milled mixture from v),
vii) adding binder(s) to the mixture from vi), optionally, solvent(s) is/are added after addition of the binder(s),
viii) optionally, adding solvent(s) to the mixture from vii),
ix) milling the mixture from vii) for 12 to 48 hours,
x) optionally, adding a second pore-forming material,
xi) if a second pore-forming material is added, milling the mixture from ix), for 10 minutes to 6 hours, and
xii) degassing the mixture from viii) or milled mixture from x).
Concept 2-6) The method of making a ceramic ion-conducting ceramic structure of Concept 2-5, further comprising forming a layer of slurry on a substrate.
Concept 2-7) The method of making a ceramic ion-conducting ceramic structure of Concept 2-5, further comprising sintering a layer of slurry of claim 5 or the layer of slurry on a substrate of claim 6 at a temperature of 800° C. to 1200° C. for 1 minute to 24 hours.
Concept 2-8) The method of making a ceramic ion-conducting structure of Concept 2-7, wherein the sintering is carried out in a low humidity or no observable humidity environment.
Concept 2-9) The method of making a ceramic ion-conducting structure of Concept 2-8, wherein the sintering is carried out under a flow of inert gas.
Concept 2-10) A solid-state, ion-conducting battery comprising:
a) cathode material or anode material;
b) a ceramic ion-conducing structure of claim 1 or made by claim 5 comprising a porous region having a plurality of pores, and a dense region, wherein the cathode material or the anode material is disposed on at least a portion of the porous region and the dense region is free of the cathode material and the anode material, and
c) a current collector disposed on at least a portion of the cathode material or the anode material.
   Concept 2-11) The solid-state, ion-conducting battery of Concept 2-10, wherein the ion-conducing ceramic structure comprises two of the porous regions, the cathode material, the anode material, and the cathode material is disposed on at least a portion of one of the porous regions forming a cathode-side porous region and the anode material is disposed on at least a portion of the other porous region forming an anode-side porous region, and the cathode-side region and the anode-side region are disposed on opposite sides of the dense region, and further comprises a cathode-side current collector and an anode-side current collector.
   Concept 2-12) The solid-state, ion-conducting battery of Concept 2-10, wherein the current collector is a conducting metal or metal alloy.
   Concept 2-13) The solid-state, ion-conducting battery of Concept 2-10, wherein the dense region of the ion-conducing ceramic material has a dimension of 1 μm to 100 μm and/or the porous region of the ion-conducing ceramic material that has the cathode material disposed thereon has a dimension of 20 μm to 200 μm and/or the porous region of the SSE material that has the anode material disposed thereon has a dimension of 20 μm to 200 μm.
   Concept 2-14) The solid-state, ion-conducting battery of Concept 2-10, wherein the cathode material, the anode material, the SSE material, and the current collector form a cell, and the solid-state, ion-conducting battery comprises a plurality of the cells, each adjacent pair of the cells is separated by a bipolar plate.

We claim:

1. A battery cell comprising
a solid-state dense region having a porosity of less than 5%; and
a solid-state first porous region having a porosity of 40% to 90%, wherein
a cathode material or an anode material is disposed on at least a portion of the first porous region,
the first porous region comprises pores and the pores interconnectedly connect opposing sides of the first porous region.

2. The battery cell of claim 1, wherein one of the opposing sides of the first porous region is at an interface between the first porous region and the dense region.

3. The battery cell of claim 1, wherein the dense region is too thin to be self-supporting and the dense region is supported by the first porous region.

4. The battery cell of claim 1, wherein the dense region is free of the cathode material and the anode material.

5. The battery cell of claim 1, wherein particles of the first porous region are fused into the dense region.

6. The battery cell of claim 1, further comprising:
a second solid-state porous region having a porosity of 40% to 90%,
a first current collector disposed on the first porous region, and
a second current collector disposed on the second porous region,
wherein,
the second porous region comprises pores and the pores connect opposing sides of the second porous region,
the cathode material is disposed on a portion of the first porous region forming a cathode-side porous region,
the anode material is disposed on a portion of the second porous region forming an anode-side porous region, and
the anode-side region and the cathode-side region are disposed on opposite sides of the dense region.

7. The battery cell of claim 1, wherein the dense region has a thickness of 1 to 40 microns.

8. The battery cell of claim 1, wherein the dense region has a thickness of 5 to 40 microns.

9. The battery cell of claim 1, wherein the anode material is disposed on the at least a portion of the first porous region and the cathode material present in a cathode that comprises an organic or a gel electrolyte.

10. The battery cell of claim 1, wherein the anode material is disposed on the at least a portion of the first porous region and the cathode material present in a cathode that comprises a liquid electrolyte.

11. A solid-state, ion-conducting battery cell comprising:
a cathode comprising a cathode material or an anode comprising an anode material;
a solid-state electrolyte (SSE) material comprising a first porous region of sintered particles having a plurality of pores, and a dense region having a thickness that is too thin to be self-supporting, wherein the cathode material or the anode material is disposed on at least a portion of the first porous region, and wherein the dense region is supported by the first porous region.

12. The solid-state ion-conducting battery cell of claim 11, wherein the dense region has a porosity of less than 5%, and the first porous region having a porosity of 40% to 90%.

13. The solid-state ion-conducting battery cell of claim 11, wherein the plurality of pores interconnectedly connect opposing sides of the first porous region

14. The solid-state ion-conducting battery cell of claim 11, wherein the plurality of pores interconnectedly connect an interface between the first porous region and the dense region and an opposing side of the first porous region.

15. The solid-state ion-conducting battery cell of claim 11, wherein the dense region is free of the cathode material and the anode material.

16. The solid-state ion-conducting battery cell of claim 11, wherein particles of the first porous region are fused into the dense region.

17. The solid state ion-conducting battery cell of claim 11, wherein the anode material is disposed on the at least a portion of the first porous region and the cathode comprises an organic or a gel electrolyte.

18. The solid-state ion-conducting battery cell of claim 11, further comprising:
a second porous region having a porosity of 40% to 90%,
a first current collector disposed on the first porous region, and
a second current collector disposed on the second porous region,
wherein,
the second porous region comprises pores and the pores connect opposing sides of the second porous region,
the cathode material is disposed on a portion of the first porous region forming a cathode-side porous region,
the anode material is disposed on a portion of the second porous region forming an anode-side porous region, and
the anode-side region and the cathode-side region are disposed on opposite sides of the dense region.

19. The solid-state ion-conducting battery cell of claim 11, wherein the dense region has a thickness of 1 to 40 microns.

20. The solid-state ion-conducting battery cell of claim 11, wherein the dense region has a thickness of 5 to 40 microns.

21. The battery cell of claim 1, wherein the porous region is a ceramic that was made with a porogen comprising an elemental carbon-containing material.

22. The battery cell of claim 1, wherein the porous region is a ceramic that was made with a porogen comprising a material selected from the group consisting of natural fibers, starches, and polymer materials.

23. The battery cell of claim 1, wherein the porous region is a ceramic that was made with a porogen comprising a first material that comprises one or more elemental carbon-containing materials and a second material comprising one or more of a material selected from the group consisting of natural fibers, starches, polymer materials and combinations thereof.
